(19) United States
(12) Patent Application Publication
(10) Pub. No.: US 2024/0126865 A1
(43) Pub. Date: Apr. 18, 2024

(54) SYSTEM AND METHOD FOR AUTHENTICATING AN INTEGRATED CIRCUIT USING A DIAMOND-BASED READ-ONLY MEMORY

(71) Applicant: EllansaLabs Inc., Addison, TX (US)

(72) Inventor: Omar Besim HAKIM, Austin, TX (US)

(21) Appl. No.: 18/532,288

(22) Filed: Dec. 7, 2023

Related U.S. Application Data
(63) Continuation-in-part of application No. 18/160,734, filed on Jan. 27, 2023, now Pat. No. 11,867,637.
(60) Provisional application No. 63/432,864, filed on Dec. 15, 2022.
(60) Provisional application No. 63/469,481, filed on May 29, 2023.
(60) Provisional application No. 63/469,483, filed on May 29, 2023.

(51) Int. Cl. G06F 21/44; G06F 21/71

(52) U.S. Cl. CPC G06F 21/44; G06F 21/71

(57) ABSTRACT

A system for authenticating an integrated circuit to be used in a computer system is disclosed. A tangible token that comprises a diamond gemstone that is affixed to the integrated circuit or a package into which the integrated circuit is mounted is used to form diamond-based read-only memory that stores information pertaining to the integrated circuit. The integrated circuit may perform an authentication operation using the stored information and a security database. Based on a result of the authentication operation, the integrated circuit may perform one or more security operations.

### CROSS-REFERENCES TO RELATED APPLICATIONS

This application is a continuation-in-part of U.S. application patent Ser. No. 18/160,734, filed Jan. 27, 2023, which claims priority to and the benefit of U.S. Provisional Application Patent Ser. No. 63,432,864, filed Dec. 15, 2022. This application also claims priority to and the benefit of U.S. Provisional Application Patent Ser. No. 63,469,481, filed May 29, 2023. This application also claims priority to and the benefit of U.S. Provisional Application Patent Ser. No. 63,469,483, filed May 29, 2023, the entire disclosures of which are hereby incorporated by reference.

### TECHNICAL FIELD

This disclosure relates to a blockchain. More specifically, this disclosure relates to a system and method for etching internal surfaces of transparent gemstones with information pertaining to an identification code and/or a blockchain for authenticating an integrated circuit.

### BACKGROUND

A blockchain is a distributed database that maintains a continuously-growing list of records, called blocks, that may be linked together to form a chain. Each block in the blockchain may contain a timestamp and a link to a previous block and/or record. The blocks may be secured from tampering and revision. In addition, a blockchain may include a secure transaction ledger database shared by parties participating in an established, distributed network of computers. A blockchain may record a transaction (e.g., an exchange or transfer of information) that occurs in the network, thereby reducing or eliminating the need for trusted/centralized third parties. In some cases, the parties participating in a transaction may not know the identities of any other parties participating in the transaction but may securely exchange information. Further, the distributed ledger may correspond to a record of consensus with a cryptographic audit trail that is maintained and validated by a set of independent computers. A blockchain may store a cryptocurrency and/or a non-fungible token.

### SUMMARY

Various embodiments of a system that includes an integrated circuit with an affixed transparent gemstone are disclosed. Broadly speaking, an integrated circuit is received that has affixed transparent gemstone that is internally etched with information pertaining to the integrated circuit. The integrated circuit may read the information from the transparent gemstone and perform a compare of the read information to a security database. Based on a result of the comparison, the integrated circuit may perform at least one security operation.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings.

FIG. 1 illustrates a system architecture according to certain embodiments of this disclosure.

FIG. 2 illustrates a side view of a tangible token according to certain embodiments of this disclosure.

FIG. 3 illustrates a computing device projecting an image retrieved from a non-fungible token based on information read from a tangible token according to certain embodiments of this disclosure.

FIG. 4 illustrates a sealed tangible token including information associated with a blockchain according to certain embodiments of this disclosure.

FIG. 5 illustrates an example of a method for manufacturing a single integrated transparent gemstone internally etched with information pertaining to a non-fungible token according to certain embodiments of this disclosure.

FIG. 6 illustrates an example of a method for manufacturing a single integrated transparent gemstone internally etched with information pertaining to a cryptocurrency according to certain embodiments of this disclosure.

FIG. 7 illustrates an example of a method for validating information etched on a tangible token according to certain embodiments of this disclosure.

FIG. 8 illustrates an example of a method for projecting information obtained from a non-fungible token associated with a tangible token according to certain embodiments of this disclosure.

FIG. 9 illustrates an example of a method for generating interest on a principle value associated with an indivisible block of cryptocurrency stored on a blockchain according to certain embodiments of this disclosure.

FIG. 10 illustrates an example computer system according to embodiments of this disclosure.

FIG. 11 illustrates an example cryptocurrency tangible token and an example NFT tangible token according to embodiments of this disclosure.

FIG. 12 illustrates an example of an integrated circuit package that includes a tangible token.

FIG. 13A illustrates an example of a tangible token attached to an exterior of an integrated circuit package.

FIG. 13B illustrates an example of a tangible token embedded in an integrated circuit package.

FIG. 14 illustrates an example of an integrated circuit with an attached tangible token.

FIG. 15 illustrates an example of a cross-section of an integrated circuit with an attached tangible token.

FIG. 16 is a block diagram depicting an embodiment of an integrated circuit that includes a lock circuit coupled to a key circuit in a tangible token.

FIG. 17 illustrates an example of a tangible token with embedded information.

FIG. 18 is a block diagram of an integrated circuit to check for the presence of a tangible token using a thermal check.

FIG. 19 illustrates an example of a system to verify the authenticity of a packaged integrated circuit to be included in a computer system.

FIG. 20 illustrates an example of a system to verify the authenticity of an unpackaged integrated circuit to be mounted on a circuit board or substrate.

FIG. 21 is a block diagram of a computer system that includes a tangible token.

FIG. 22 illustrates a flow diagram depicting an embodiment of a method for authenticating a packaged integrated circuit using an associated tangible token.

FIG. 23 illustrates a flow diagram depicting an embodiment of a method for authenticating an unpackaged integrated circuit using an associated tangible token.

FIG. 24 illustrates a flow diagram depicting an embodiment of a method for retrieving data regarding an integrated circuit using information internally etched into a tangible token associated with the integrated circuit.

FIG. 25 illustrates a flow diagram depicting an embodiment of a method for an integrated circuit to read information embedded in an associated tangible token.

FIG. 26 illustrates a flow diagram depicting an embodiment of a method for an integrated circuit to perform a thermal check to determine a presence of an associated tangible token.

FIG. 27 illustrates a flow diagram depicting an embodiment of a method for a computer system to read information embedded in an associated tangible token.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read-only memory (ROM), random-access memory (RAM), a hard disk drive, a compact disc (CD), a digital video disc (DVD), solid-state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The term “tangible token” may refer to a physical object that includes information etched or provided internally within the physical object, and the physical object is at least partially transparent such that the information may be read.

The term “tangible token” and “single integrated transparent gemstone” may be used interchangeably herein.

A “private key” may refer to a cryptographic large, randomly-generated number with multiple digits represented as a string of alphanumeric characters. The private key may be used to sign transactions and to prove ownership of a blockchain address. The private key may encrypt and decrypt data.

A “public key” may refer to a cryptographic key that can be obtained and used by anyone to encrypt messages intended for a particular recipient, such that the encrypted messages can be deciphered only by using a second key that is known only to the recipient, e.g., having the private key.

A “digital wallet” may consist of a set of public addresses and private keys. Any device may deposit cryptocurrency in a public address, but funds cannot be removed from an address without the corresponding private key.

A “blockchain” may refer to a distributed database that maintains a continuously-growing list of records, called blocks, that may be linked together to form a chain.

A “blockchain system” may refer to a group of nodes that cooperate to maintain and build a blockchain according to a protocol.

A “node” may refer to a computing device participating in the blockchain system and that is connected to and interacts with the blockchain.

A “hash” may refer to an output of a cryptographic function used in securing information in a blockchain.

A “consensus algorithm” may refer to a process used to achieve approval or agreement on a single data value in a distributed system.

The term “feedback loop” may refer to a mutually dependent relationship between two parties in a given system.

The term “proof of work” may refer to a cryptographic process to ensure data security and/or uniformity.

The term “transparent” or “transparency” may refer to a property of a gemstone or material that enables at least some information (e.g., etching, laser mark, engraving, etc.) included within the gemstone or material to be visible. In some embodiments, the information may not be visible to the naked eye (e.g., less than 0.1 millimeter in size). In some embodiments, the information may be visible to the naked eye (e.g., greater than 0.1 millimeters in size).

A “proof of record” may refer to a compression process using the consensus algorithm designed to create a tiered, access-oriented, and adjustable blockchain architecture used by the blockchain system described herein.

The term “SHA” may refer to Secure Hash Algorithm.

The term “SHA-2” may refer to a set of cryptographic hash functions designed by the United States National Security Agency.

The term “SHA256” may refer to a member of the SHA-2 cryptographic hash functions and may generate an almost-unique 256-bit data signature.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment and not intended to intimate that the scope of the disclosure, including the claims, is limited to that embodiment.

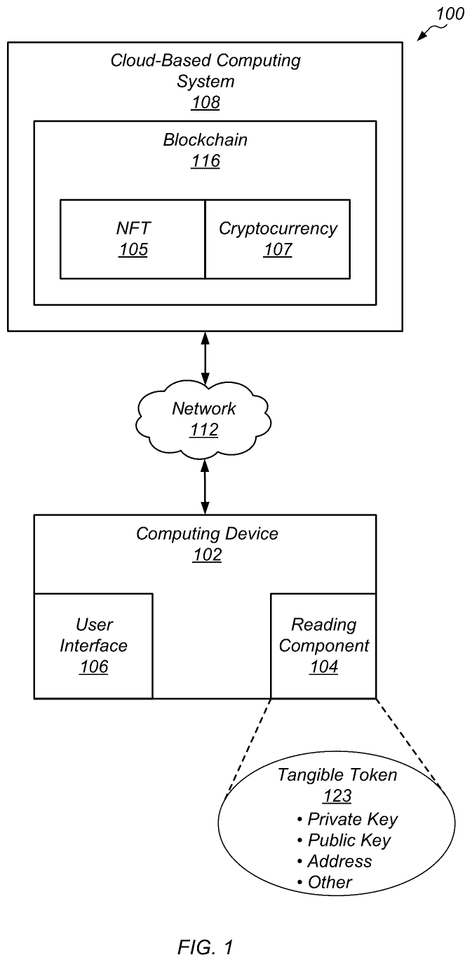

FIGS. 1 through 10, discussed below, and the various embodiments used to describe the principles of this disclosure in this patent document are by way of illustration only and should not be construed in any way to limit the scope of the disclosure.

Blockchains may refer to a distributed ledger maintained by and stored on one or more computing devices in a decentralized fashion. A blockchain may provide access to immutable records of information. Blockchains may be published to the public. A blockchain may be stored on numerous computing devices connected via a network in a cloud-based computing system. Accordingly, since numerous computing devices (e.g. nodes) may alter the blockchain (e.g., by adding a new block), security is an important consideration when implementing a blockchain. Conventionally, to secure the blockchain, a proof of work is used that ensures reliable evidence that a significant amount of processing resources (such as time and/or processing resources) was used during the creation of a new block to be added to the blockchain. The Bitcoin implementation of blockchain requires a node to use processing resources to find a nonce value that, when hashed with the rest of a block header, results in a hash value which has a predetermined number of leading zeroes.

Also, some blockchain technologies, like Bitcoin, provide blockchains directly to all the participating nodes in a blockchain system. The blockchains may continue to grow in size as nodes add blocks for an unrestricted amount of time. There are different kinds of blockchains, such as permission-less and permissioned. In a permission-less blockchain, any entity may participate without an identity. In a permissioned blockchain, each entity that participates in the blockchain is identified and known. An example of a permissioned blockchain is a distributed ledger (e.g., a hyperledger). The permissions cause the participating nodes to view only the appropriate records of transactions in the distributed ledger. Programmable logic may be implemented as rules and/or smart contracts that are executed on the distributed ledger. In some embodiments, the rules may be analytics-based and may specify scenarios when updates to the distributed ledger are to be made. Using the analytics-based rules may make each node an active participant by updating the distributed ledger at specified times.

A smart contract may refer to a computer protocol with one or more functions capable of digitally facilitating, verifying, and/or assisting with transactions associated with the blockchain. The smart contract may include a function configured to authorize and/or authenticate a transaction request made by a user, a function configured to add content to the distributed ledger (e.g., a non-fungible token, a cryptocurrency, and/or the like), a function configured to verify the content of the blockchain, a function configured to allow certain authorized users to view the content of the blockchain, a function configured to incentivize one or more transactions, and/or the like.

A non-fungible token (NFT) may refer to a non-interchangeable unit of data stored on a blockchain that can be sold and/or traded. In some embodiments, types of NFT data units that may be associated with digital files such as digital jewelry model designs, photos, images, videos, and/or audio. NFTs differ from cryptocurrencies, such as Bitcoin, because cryptocurrencies are fungible (interchangeable) and NFTs are non-fungible.

A cryptocurrency is a digital or virtual currency that is secured by cryptography and stored on a blockchain. Cryptocurrency is a form of a digital asset based on a network that is distributed across a large number of computers. Cryptocurrency transactions may be governed via a smart contract that controls transfers. Private keys may be used to sign transactions to enable the cryptocurrency to move from one digital wallet to another digital wallet. A public key may be used by the receiving digital wallet to verify the transfer is valid.

Conventionally, certain items, such as jewelry, may be sold to customers. The jewelry may be unique in that it is one of a kind or at least one of a limited number of jewelries having a particular design or designed by a particular jeweler. To add value or make the piece of jewelry more desirable, in some embodiments, an NFT may be created that stores a digital design of the jewelry on a block of a blockchain. The NFT's information may be etched internally on a gemstone and the gemstone may be provided to the customer that bought the piece of jewelry. The NFT information may include an address of where the NFT is located on the blockchain and may include a public key and a private key to verify ownership and the transaction that occurred when the customer bought the jewelry. In some embodiments, the information may be etched at a size that is not visible to the naked eye (e.g., less than 0.1 millimeter). However, using a magnifying glass or a microscope, for example, a user may read the information that is inscribed or etched internally within the gemstone. In some embodiments, the information etched on the gemstone may be partially or completely obscured with a bezel (e.g., gold) around an outer edge of the gemstone. In some embodiments, a graphic inscribed or etched internally on the inside of the gemstone may be visible when the bezel is obscuring the information. The bezel may be damaged or removed to view all of the blockchain information etched on the gemstone. Such a technique may enable the gemstone to be circulated without someone casually reading the blockchain information. The gemstone may be a sapphire, diamond, emerald, jade, amethyst, pearl, amber, rose quartz, turquoise, moonstone, or the like. The gemstones may be structurally resilient and may not decay or degrade for thousands of years. Thus, the information included with the gemstones may be preserved for thousands of years. The gemstone may be referred to as a tangible token and/or a single integrated transparent gemstone herein.

In some embodiments, more than one wafer (e.g., gemstone wafer) may be used to create a single integrated transparent gemstone. In some embodiments, a sapphire wafer may be shaped like a disk, which may be 1 inch, 2 inches, 3 inches, 4 inches, etc. A first sapphire wafer may include an internal side and an external side. The internal side of the first sapphire wafer may be laser etched (e.g., via a lithological process) to include various information, such as a private key to a block storing an NFT or a cryptocurrency, a public key to the block on the blockchain, an address of the block on the blockchain, an image associated with the block on the blockchain, among other things.

The information may be etched, engraved, indented, and/or marked on the internal side of the first sapphire wafer. For example, a machine including a laser may be used to etch the information onto the internal side of the wafer by melting a surface of the internal side to correspond to the information (e.g., melts the alphanumeric characters of the private key, the public key, and/or the address). A second sapphire wafer may be aligned with the first sapphire wafer such that the information included on the internal side of the first sapphire wafer is encapsulated between the first and second sapphire wafers. That is, the information does not extend beyond a perimeter created by the aligned first and second sapphire wafers. The two sapphire wafers may be fused together such that the information is hermetically sealed between the two wafers. A flame fusion process may be used, for example, to fuse two sapphire wafers together. In some embodiments, fusing the two sapphire wafers may include bonding by molecular adhesion.

Either or both of the first and second sapphire wafers may be transparent such that the information may be visible to the naked eye or via a magnifying device if the information is etched at a size smaller than the naked eye can visibly detect. The two wafers may be connected by bonding by molecular adhesion. The hermetic seal may form a barrier to diffusion of humidity or gas or liquid chemicals.

In some embodiments, the internal side of the first sapphire wafer may include a recess forming a pattern of a graphical element and/or alphanumeric characters and the recess may be filled with a material. By fusing and/or bonding through molecular adhesion the sapphire wafers together a monolithic structure may be formed that includes the information enclosed internally. Accordingly, the information etched, engraved, indented, and/or marked internally within the single integrated transparent gemstone may be protected from tampering for thousands of years due to the strength and durability properties of the gemstone. To fuse the two wafers together, a mechanism may be used to apply heat and pressure such that the internal sides of each wafer bond with one another and form the hermetic seal. In some embodiments, bonding techniques may be used where the bond is transparent and each surface of the internal sides of the wafers are machined very flat and smooth to enable optimized contact. In some embodiments, a welding process may be used to fuse the two wafers together. In some embodiments, an adhesion layer may be included between the first sapphire wafer and the second sapphire wafer.

In some embodiments, the melting temperature of certain materials for the wafers may be 1,790 degrees Celsius. In some embodiments, a certain material may be selected to be deposited in a recess of the internal side of the first sapphire wafer. The certain material may have a melting temperature of about 1,760 degrees Celsius. After the single integrated transparent gemstone is created, it may have a high resistance to thermal aggression (e.g., fire). Accordingly, the single integrated transparent gemstone may be extremely durable for thousands of years. In some embodiments, by bonding by molecular adhesion, mineral materials may be used, and the optical properties may be stable over time such that the visibility of the information remains constant, continuous, etc. over time.

In some embodiments, the tangible token may be inserted into a computing device. The computing device may include a slot in which the tangible token is deposited and/or the computing device may include a reading component (e.g., sensor, camera, etc.) that is able to identify the tangible token and read the information internally included within the tangible token. The computing device may transmit, via a network, the information to one or more computing devices storing the blockchain to validate whether the information is valid. In some embodiments, the computing device may include a projecting device configured to project any data (e.g., image) associated with the information that is obtained from the blockchain when the information is validated. In some embodiments, the tangible token may be sealed in a material that is opaque and prevents the information from being visible at all. In order to view the information, the material may be cracked, pealed, broken, torn open, etc. such that the material is removed from the tangible token.

Turning now to the figures, FIG. 1 depicts a system architecture 10 according to some embodiments. The system architecture 10 may include one or more computing devices 102 communicatively coupled to a cloud-based computing system 108. The cloud-based computing system 108 may include one or more servers. Each of the computing device 102 and/or servers included in the cloud-based computing system 108 may include one or more processing devices, memory devices, and/or network interface devices. The network interface devices may enable communication via a wireless protocol for transmitting data over short distances, such as Bluetooth, ZigBee, NFC, etc. Additionally, the network interface devices may enable communicating data over long distances, and in one example, the computing device 102 and the cloud-based computing system 108 may communicate with a network 112. Network 112 may be a public network (e.g., connected to the Internet via wired (Ethernet) or wireless (WiFi)), a private network (e.g., a local area network (LAN) or wide area network (WAN)), or a combination thereof. Network 112 may also comprise a node or nodes on the Internet of Things (IoT).

The computing device 102 may be any suitable computing device, such as a laptop, tablet, smartphone, or computer. The computing device 102 may include a display capable of presenting a user interface 106. The user interface 106 may be implemented in computer instructions stored on the one or more memory devices of the cloud-based computing system 108 and/or computing device 102 and may be executable by the one or more processing devices of the cloud-based computing system 108 and/or computing device 102. The user interface 106 may present various screens to a user. For example, the user interface 106 may present a screen that indicates whether information pertaining to a non-fungible token and/or a cryptocurrency is valid or not valid. The user interface 106 may present a screen that indicates that the owner of the non-fungible token and/or cryptocurrency is authorized or not authorized. The user interface 106 may present a screen that displays data associated with a non-fungible token and/or cryptocurrency. For example, the screen may present a digital model of a jewelry design associated with the non-fungible token.

In some embodiments, the user interface 106 is a stand-alone application installed and executing on the computing device 102. In some embodiments, the user interface 106 (e.g., website) executes within another application (e.g., web browser). The cloud-based computing system 108 and the computing device 102 may also include instructions stored on one or more memory devices that, when executed by the one or more processing devices of the computing device 102 perform operations of any of the methods described herein.

In some embodiments, the cloud-based computing system 108 may include one or more servers that form a distributed computing architecture. The servers may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers may include one or more processing devices, memory devices, data storage, and/or network interface cards. The servers may be in communication with one another via any suitable communication protocol.

The cloud-based computing system 108 may include a blockchain 116. The blockchain 116 may refer to a distributed ledger that is decentralized and controlled by peer-to-peer authorization. For example, to add a block to the blockchain 116, a consensus protocol may be used where more than a threshold (e.g., more than 75%) of the nodes on the blockchain 116 agree to allow a block to be added to the blockchain 116. A node may refer to a computing device (e.g., server) that has an instance of the blockchain 116 stored in memory and/or executed by a processing device.

The blockchain 116 may store one or more blocks that each have a respective address. There may also be private and public keys associated with the blocks and users that perform transactions using their computing devices. Further, each block may be associated with a smart transaction that controls the transactions and records each and every transaction in the blockchain 116. In some embodiments, the blocks may store NFTs 105. The NFTs 105 may further store images, audio, video, or the like. In one example, the NFTs 105 may store a digital model of a jewelry design. The blockchain 116 may also include one or more blocks that store a cryptocurrency 107. The cryptocurrency may be associated with a number of units and an identifier for the cryptocurrency. Both the NFTs 105 and the cryptocurrency 107 may include metadata associated with an owner of the NFTs 105 and the cryptocurrency 107. In some embodiments, any information associated with the NFTs and/or the cryptocurrency 107 may be stored as metadata in the respective block of the blockchain 116.

As depicted, a tangible token 123 may be manufactured by fusing together two wafers of a gemstone to form a single integrated transparent gemstone, or dongle. The tangible token 123 may include internally etched information including, but not limited to, at least a private key associated with the blockchain 116 and a user, a public key associated with the blockchain 116 and a user, an address of the blockchain 116, an image, text, or some combination thereof. The address of the blockchain may include a string of text that uniquely identifies the source or destination of a transaction. The blockchain 116 may have an address that is created by a cryptographic operation. The address of a blockchain 116 may function akin to an electronic mail address. It may refer to a specific destination of where a block storing an NFT or a cryptocurrency is located. To that end, using the keys (e.g., private and/or public) data associated with a block at the address may be validated, obtained, authorized, secured, displayed, transferred, etc.

The computing device may include a reading component 104. The reading component 104 may be a sensor and/or a camera. The tangible token 123 may be placed proximately to or touch the reading component 104, and the reading component 104 may perform an operation to read the information included internally within the tangible token 123. For example, the reading component 104 may be a camera and may obtain or stream an image of the tangible token 123. A processing device of the computing device 102 may receive the image and perform optical character recognition to decipher the information that is internally etched within the tangible token 123. The computing device 102 may transmit the information to the cloud-based computing system 108 to obtain data related to the tangible token's 123 private key, public key, and/or address. If the information is validated as belonging to the owner requesting the data, the data may be retrieved from the blockchain 116 and returned to the computing device 102. In some embodiments, a new transaction may be entered for the block that was accessed.

In some embodiments, the tangible token 123 may include a single transparent gemstone. The single transparent gemstone may be produced by etching information pertaining to a blockchain on a gemstone surface during (e.g., in the middle of) a growing process of the gemstone, and the single transparent gemstone may be grown to a state where the information is internally included within the single transparent gemstone such that it is not physically exposed to elements outside an outer surface of the single transparent gemstone. The information may be wholly included within an outer surface perimeter of the single transparent gemstone. The information may include the blockchain information.

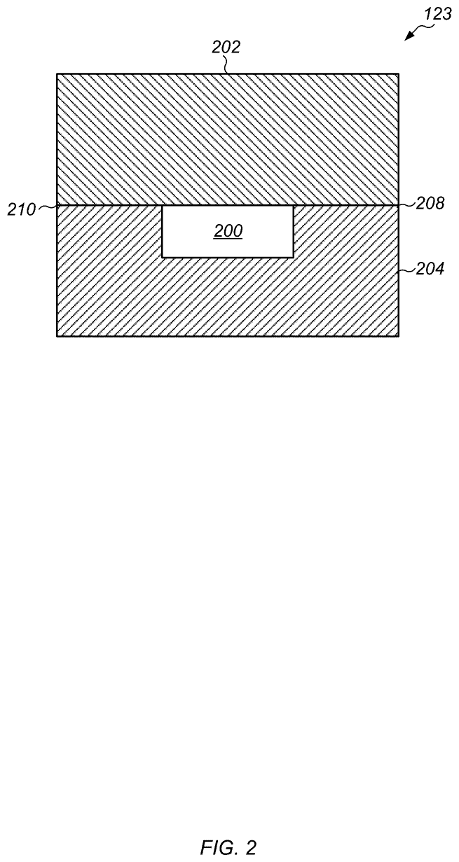

FIG. 2 illustrates a side view of a tangible token 123 according to certain embodiments of this disclosure. As depicted, a first transparent gemstone 204 includes a first internal side 210, and a second transparent gemstone 202 includes a second internal side 208. The first internal side 210 includes an etching 200 that is recessed due to a laser etching machine, for example. The etching 200 may be filled with a material, in some embodiments. The material may include a mineral material, such as a metal and/or liquid (e.g., paint). In some embodiments, the etching 200 may represent the information associated with the blockchain 116, such as the private key, public key, and/or address. The etching 200 may be sized smaller than can be viewed by the naked eye (e.g., less than 0.1 millimeter), in some embodiments. Alternatively, the etching 200 may be bigger than visible to the naked eye (e.g., more than 0.1 millimeter). Each of the first transparent gemstone 204 and the second transparent gemstone 202 may be sapphire, diamond, or the like. As depicted, the etching 200 representing the information is encapsulated within a perimeter of the tangible token 123 such that the information does not extend beyond the perimeter. In this way, a hermetic seal is created after the first and second transparent gemstones are molecularly fused together.

In some embodiments, the tangible token 123 may be grown in a lab from sapphire or diamond such that there is no fusion of two transparent gemstones. In some embodiments, the information is etched during a growing process (e.g., in the middle of the growing process) of a single transparent gemstone and the information is etched on a surface of the partially grown single transparent gemstone. Once the information is etched on the gemstone surface, the growing process may continue such that the information is included internally within a fully grown single transparent gemstone. The gemstone may include obtaining a small slice of a gemstone and placing the gemstone in a crucible container. A chamber of the crucible container may be filled with ingredients (e.g., a blended liquid of minerals) that feeds the gemstone growth, and the growth may be accomplished at a certain temperature (e.g., 1,000 degrees Celsius) or within a range of temperatures (e.g., 1,000 degrees Celsius to 1,500 degrees Celsius). The gemstone may be grown naturally by recreating conditions in which gems grow in the earth. The chamber may be sealed with and pressure may be added to the chamber. A combination of ingredients, heat, and pressure may be applied for a certain period of time to enable the gem to crystallize and grow. To grow a diamond in a lab, carbon may be exposed to high pressure and temperature in a controlled environment for a certain amount of time (e.g., 10-12 months).

During the growing process, the conditions (e.g., pressure and temperature) may be modified to enable the growing gemstone to be accessed within the chamber and laser-etched with the information pertaining to the NFT and/or cryptocurrency. The partially grown gemstone may be placed under the growing conditions again so growth of the gemstone may begin again and the information internally included within the outer edge/surface of the fully grown gemstone.

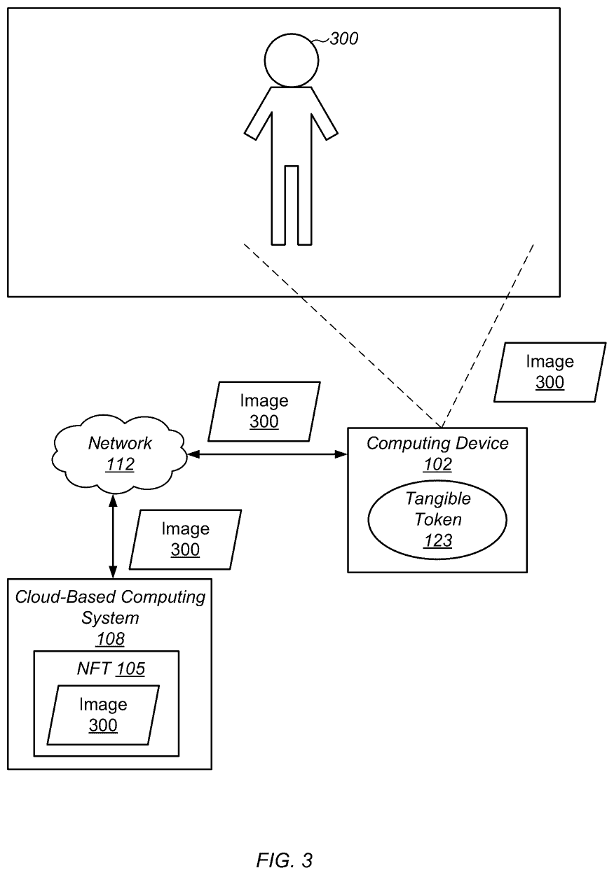

FIG. 3 illustrates a computing device projecting an image 300 retrieved from a non-fungible token 105 based on information read from a tangible token 123 according to certain embodiments of this disclosure. The computing device 102 may use its reading component 104 to read the information internally included within the tangible token 123. The information may include an address of the blockchain 116, a public key associated with the blockchain 116, and/or a private key associated with the blockchain 116. The computing device 102 may connect to the cloud-based computing system 108 via the network 112 and transmit the information to the cloud-based computing system 108. The cloud-based computing system 108 may receive the information and validate the owner of the NFT 105 is associated with the private key at the address specified in the information. Once the NFT 105 is validated for the owner's private key, the cloud-based computing system 108 may retrieve an image 300 from the block associated with the NFT 105. The image 300 may be transmitted, via the network 112, to the computing device 102. The computing device 102 may use a projector to project the image 300 on a surface, as depicted (e.g., a person is projected on the surface). In some instances, the image 300 may represent a jewelry design of a unique piece of j ewelry. In some embodiments, the computing device 102 may present the image 300 on the user interface 106.

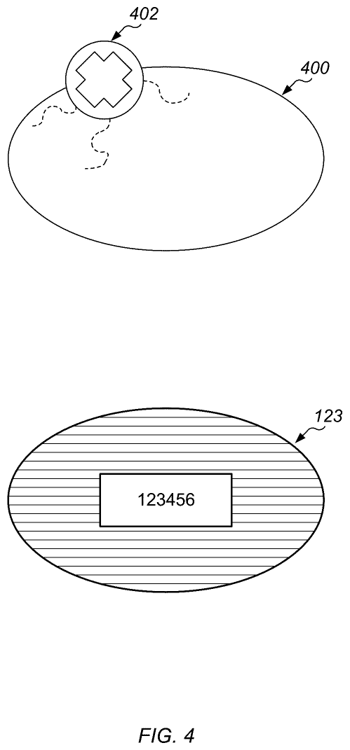

FIG. 4 illustrates a sealed tangible token 400 including information associated with a blockchain according to certain embodiments of this disclosure. As depicted, the sealed tangible token 400 may be covered in an opaque material such that information etched internally within the tangible token 123 is not visible. The opaque material may include wax, paint, rubber, plastic, etc. To remove the opaque material, it may be cracked (e.g., represented by the X 402) and/or peeled off from the underlying tangible token 123. As depicted, once the opaque material is removed, the tangible token 123 is viewable and its transparent property enables the private key (“123456”) to be read, either by the naked eye or with a magnifying object or the computing device 102.

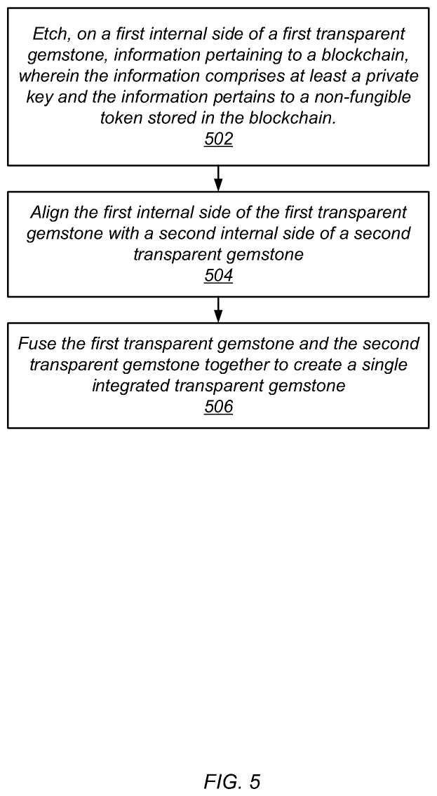

FIG. 5 illustrates an example of a method 500 for manufacturing a single integrated transparent gemstone internally etched with information pertaining to a non-fungible token according to certain embodiments of this disclosure. At block 502, a laser etching machine may etch, on a first internal side of a first transparent gemstone, information pertaining to a blockchain. The laser etching and/or engraving machine may include a laser, a controller, and a surface. The laser may emit a high quality monochromatic beam that allows the controller to trace patterns onto the surface. The laser may etch out and/or engrave out material of the substrate being targeted (e.g., the sapphire). In some embodiments, a material is added to the recession created by the etching such that the material fills the recession. The material may be detected and/or read by a reading component of a computing device performing optical character recognition, computer vision, or the like.

The information may include at least a private key associated with a blockchain, a public key associated with a blockchain, and/or an address associated with the blockchain. In some embodiments, the information may be associated with a non-fungible token stored on the blockchain. The information may include an image of a digital jewelry design, artwork, a logo, any suitable image, graphic design, text content, a symbol, a character, or some combination thereof. The information may be machine-readable and/or human-readable. In some embodiments, the information is etched to a size that is not visible to the naked eye (e.g., less than 0.1 millimeter) on the internal side of the first transparent gemstone. In some embodiments, the information is etched to a size that is readable by the naked eye of a human (e.g., greater than 0.1 millimeter). In some embodiments, the gemstone is a sapphire, diamond, etc.

At block 504, the first internal side of the first transparent gemstone may be aligned with a second internal side of a second transparent gemstone. The first and second transparent gemstones may be wafers. The aligning may encapsulate the information within a perimeter of the first and second internal sides such that the information does not extend beyond the perimeter.

At block 506, the first and second transparent gemstones may be fused together to create a single integrated transparent gemstone including the internally etched information. The fusing may provide a hermetic seal that prevents the information from being exposed to gas, pressure, etc. In some embodiments, the single integrated transparent gemstone may be attached to a piece of jewelry (e.g., a necklace, a bracelet, an anklet, a ring, an earring, etc.).

In some embodiments, the method 500 may include sealing the single integrated transparent gemstone in an opaque material such that the information is not visible. The opaque material may include clay, wax, rubber, plastic, paper, etc. To view the information included internally within the single integrated transparent gemstone, the opaque material may be removed, peeled, cracked, broken, etc. Once the opaque material is removed, the single integrated transparent gemstone may be examined to identify and determine the information internally etched within the single integrated transparent gemstone.

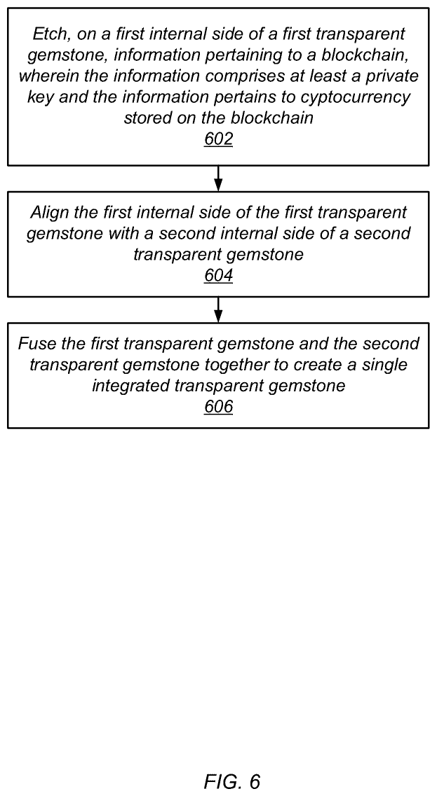

FIG. 6 illustrates an example of a method 600 for manufacturing a single integrated transparent gemstone internally etched with information pertaining to a cryptocurrency according to certain embodiments of this disclosure. At block 602, a laser etching machine may etch, on a first internal side of a first transparent gemstone, information pertaining to a blockchain. The laser etching and/or engraving machine may include a laser, a controller, and a surface. The laser may emit a high quality monochromatic beam that allows the controller to trace patterns onto the surface. The laser may etch out and/or engrave out material of the substrate being targeted (e.g., the sapphire). In some embodiments, a material is added to the recession created by the etching such that the material fills the recession. The material may be detected and/or read by a reading component of a computing device performing optical character recognition, computer vision, or the like.

The information may include at least a private key associated with a blockchain, a public key associated with a blockchain, and/or an address associated with the blockchain. In some embodiments, the information may be associated with a cryptocurrency stored on the blockchain and/or stored in a digital wallet associated with the owner of the cryptocurrency. The information may be machine-readable and/or human-readable. In some embodiments, the information is etched to a size that is not visible to the naked eye (e.g., less than 0.1 millimeter) on the internal side of the first transparent gemstone. In some embodiments, the information is etched to a size that is readable by the naked eye of a human (e.g., greater than 0.1 millimeter). In some embodiments, the gemstone is a sapphire, diamond, etc.

At block 604, the first internal side of the first transparent gemstone may be aligned with a second internal side of a second transparent gemstone. The first and second transparent gemstones may be wafers. The aligning may encapsulate the information within a perimeter of the first and second internal sides such that the information does not extend beyond the perimeter.

At block 606, the first and second transparent gemstones may be fused together to create a single integrated transparent gemstone including the internally etched information. The fusing may provide a hermetic seal that prevents the information from being exposed to gas, pressure, etc.

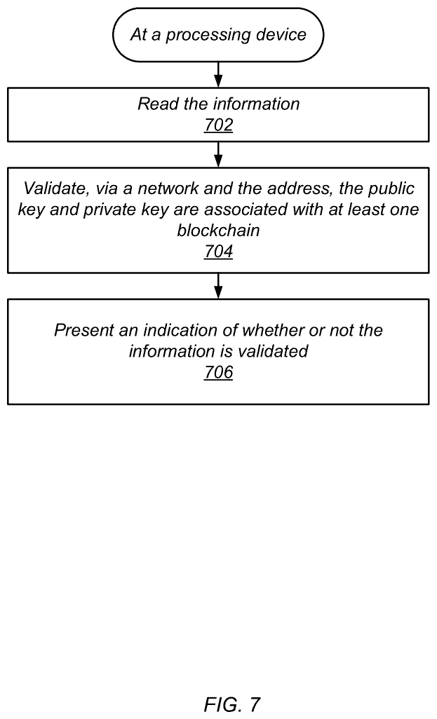

FIG. 7 illustrates an example of a method 700 for validating information etched on a tangible token according to certain embodiments of this disclosure. The method 700 may be performed by processing logic that may include hardware (circuitry, dedicated logic, etc.), software, or a combination of both. The method 700 and/or each of their individual functions, subroutines, or operations may be performed by one or more processors of a computing device (e.g., any component of cloud-based computing system 108 and/or computing device 102 of FIG. 1) implementing the method 700. The method 700 may be implemented as computer instructions stored on a memory device and executable by the one or more processors. In certain implementations, the method 700 may be performed by a single processing thread. Alternatively, the method 700 may be performed by two or more processing threads, each thread implementing one or more individual functions, routines, subroutines, or operations of the methods.

At block 702, the processing device may read the information etched internally within the single integrated transparent gemstone. The information may be machine-readable (e.g., a barcode, a quick response code, binary, alphanumeric characters, etc.). In some embodiments, the single integrated transparent gemstone may be sapphire, diamond, or another gemstone. In some embodiments, the single integrated transparent gemstone may be a one-inch disk, a two-inch disk, a three-inch disk, or a four-inch disk.

The single integrated transparent gemstone may be inserted into a computing device that uses a reading component (e.g., sensor, camera, etc.) to read the information and the information may be processed using optical character recognition or other suitable techniques via a processing device of the computing device. The information may include a private key associated with a block on a blockchain, a public key associated with the block on the blockchain, and/or an address of the block on the blockchain. In some embodiments, the information may include text and/or an image that is etched internally within the single integrated transparent gemstone.

At block 704, the processing device may validate, via a network and the address, the public key and/or the private key are associated with at least the block on the blockchain. If the key(s) are validated, at block 706, the processing device may present an indication that the information is validated on a user interface of a computing device. If the key(s) are not validated, the processing device may present an indication that the information is not validated and prevent any further interaction with the block on the blockchain.

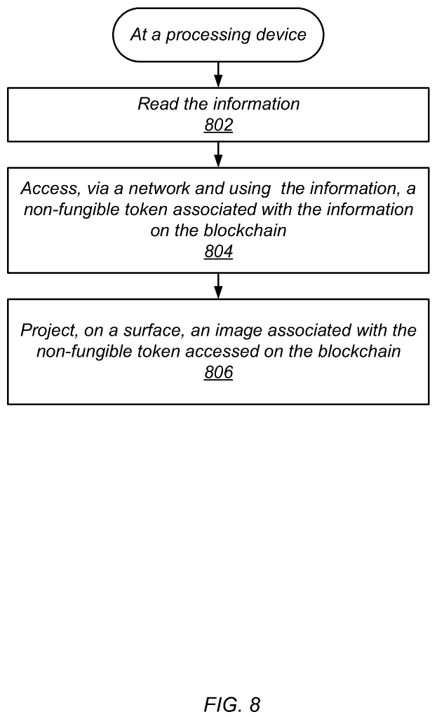

FIG. 8 illustrates an example of a method 800 for projecting information obtained from a non-fungible token associated with a tangible token according to certain embodiments of this disclosure. The method 800 may be performed by processing logic that may include hardware (circuitry, dedicated logic, etc.), software, or a combination of both. The method 800 and/or each of their individual functions, subroutines, or operations may be performed by one or more processors of a computing device (e.g., any component of cloud-based computing system 108 and/or computing device 102 of FIG. 1) implementing the method 800. The method 800 may be implemented as computer instructions stored on a memory device and executable by the one or more processors. In certain implementations, the method 800 may be performed by a single processing thread. Alternatively, the method 800 may be performed by two or more processing threads, each thread implementing one or more individual functions, routines, subroutines, or operations of the methods.

At block 802, the processing device may read the information etched internally within the single integrated transparent gemstone. The information may include a private key associated with a block on a blockchain, a public key associated with the block on the blockchain, and/or an address of the block on the blockchain. In some embodiments, the information may include text and/or an image that is etched internally within the single integrated transparent gemstone.

At block 804, the processing device may access, via a network and using the information, a non-fungible token associated with the information on the blockchain. Any data included in transactions associated with the non-fungible token may be downloaded to the computing device including the processing device. For example, one or more images, text, audio, video, etc. may be downloaded to the computing device. In one embodiment, the data may include a digital model of a jewelry design that is downloaded and projected on a surface (e.g., wall, floor, screen, etc.). In some embodiments, the image may include a patent design, artwork, a drawing, text, any suitable image, etc. that may be downloaded and projected onto a surface and/or displayed in a user interface of the computing device 102.

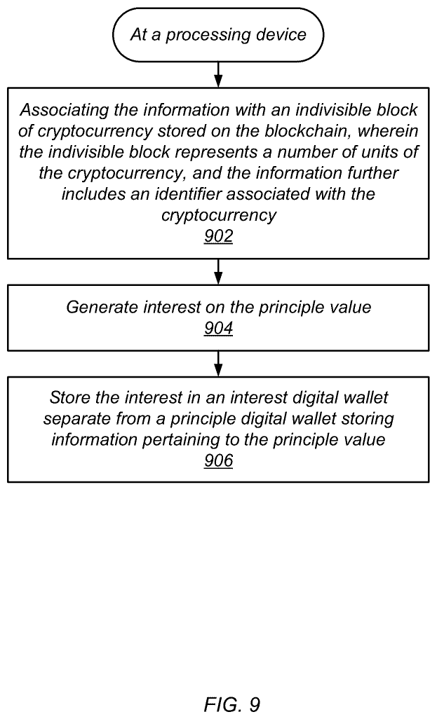

FIG. 9 illustrates an example of a method 900 for generating interest on a principle value associated with an indivisible block of cryptocurrency stored on a blockchain according to certain embodiments of this disclosure. The method 900 may be performed by processing logic that may include hardware (circuitry, dedicated logic, etc.), software, or a combination of both. The method 900 and/or each of their individual functions, subroutines, or operations may be performed by one or more processors of a computing device (e.g., any component of cloud-based computing system 108 and/or computing device 102 of FIG. 1) implementing the method 900. The method 900 may be implemented as computer instructions stored on a memory device and executable by the one or more processors. In certain implementations, the method 900 may be performed by a single processing thread. Alternatively, the method 900 may be performed by two or more processing threads, each thread implementing one or more individual functions, routines, subroutines, or operations of the methods.

At block 902, the processing device may associate the information with an indivisible block of cryptocurrency stored on the blockchain. The indivisible block may represent a number of units of the cryptocurrency. Information may be etched and/or engraved internally within the tangible token. The information may include an identifier associated with the cryptocurrency. For example, for Bitcoin, the identifier may be the Bitcoin logo that is etched and/or engraved internally within the tangible token, as well other information including a private key and/or a public key to an NFT and/or cryptocurrency and/or an address of a block on a blockchain stored on several computing devices.

At block 904, the processing device may generate interest (e.g., a monetary amount determined based on a percentage of the principle value) on the principle value of a number of units of the cryptocurrency represented by the indivisible block on the blockchain. The interest may be stored, at block 906, in an interest digital wallet separate from a principle digital wallet storing information pertaining to the principle value. In some embodiments, the indivisible block of cryptocurrency on the block may be registered to a first owner, and the processing device may transfer ownership of the indivisible block of cryptocurrency on the blockchain to a second owner To perform the transfer, the private key may be used and validated to ensure the first owner owns the indivisible block on the blockchain. Once verified, a transaction may be added to the indivisible block that indicates ownership has passed from the first owner to the second owner and the transaction may be stored in the ledger of the block and may include a timestamp of the transaction.

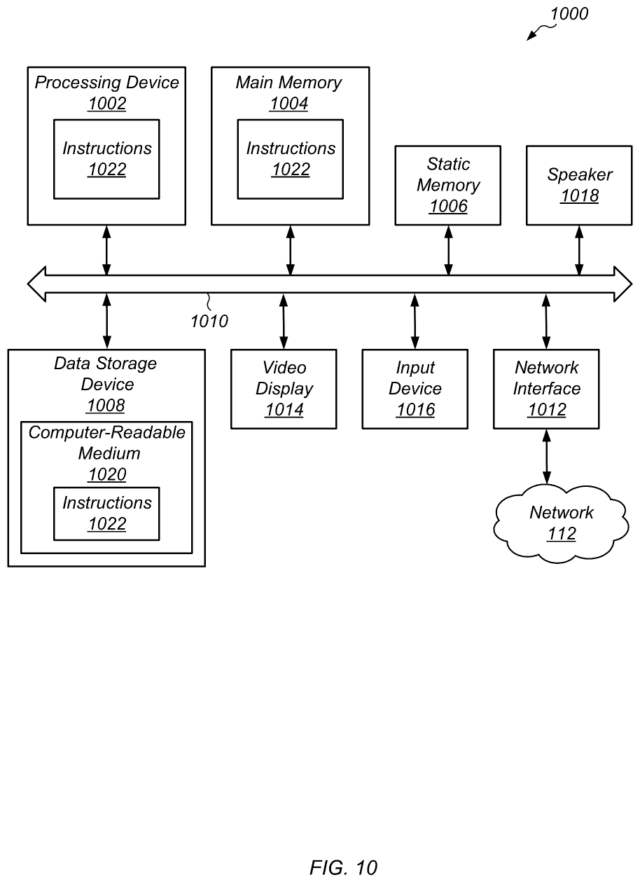

FIG. 10 illustrates an example of a computer system 1000, which can perform any one or more of the methods described herein. In one example, computer system 1000 may include one or more components that correspond to the computing device 102 and/or one or more servers of the cloud-based computing system 108 of FIG. 1. The computer system 1000 may be connected (e.g., networked) to other computer systems in a LAN, an intranet, an extranet, or the Internet. The computer system 1000 may operate in the capacity of a server in a client-server network environment. The computer system 1000 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1000 includes a processing device 1002, a main memory 1004 (e.g., read-only memory (ROM), solid-state drive (SSD), flash memory, dynamic-random access memory (DRAM) such as synchronous DRAM (SDRAM)), a static memory 1006 (e.g., solid-state drive (SSD), flash memory, static random-access memory (SRAM)), and a data storage device 1008, which communicate with each other via a bus 1010.

Processing device 1002 represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions for performing any of the operations and steps of any of the methods discussed herein.

The computer system 1000 may further include a network interface device 1012. The computer system 1000 also may include a video display 1014 (e.g., a liquid crystal display (LCD) or a cathode ray tube (CRT)), one or more input devices 1016 (e.g., a keyboard and/or a mouse), and one or more speakers 1018 (e.g., a speaker). In one illustrative example, the video display 1014 and the input device(s) 1016 may be combined into a single component or device (e.g., an LCD touch screen).

The data storage device 1008 may include a computer-readable medium 1020 on which the instructions 1022 embodying any one or more of the methodologies or functions described herein are stored. The instructions 1022 may also reside, completely or at least partially, within the main memory 1004 and/or within the processing device 1002 during execution thereof by the computer system 1000. As such, the main memory 1004 and the processing device 1002 also constitute computer-readable media. The instructions 1022 may further be transmitted or received over a network 20 via the network interface device 1012.

While the computer-readable medium 1020 is shown in the illustrative examples to be a single medium, the term “computer-readable medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

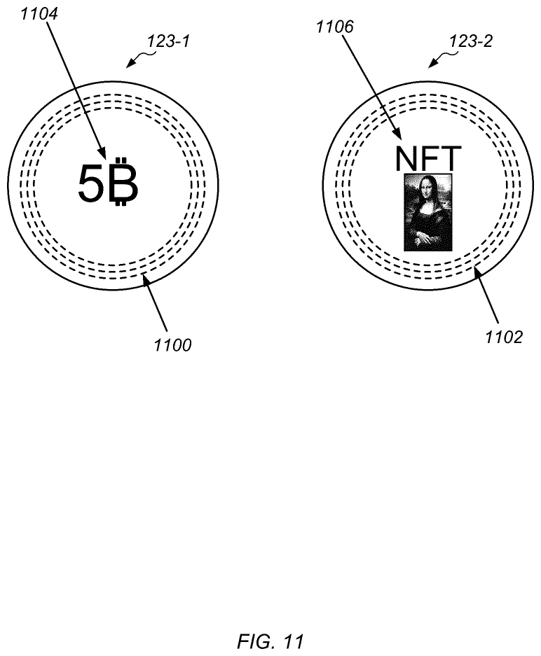

FIG. 11 illustrates an example cryptocurrency tangible token 123-1 and an example NFT tangible token 123-2 according to embodiments of this disclosure. The cryptocurrency tangible token 123-1 includes associated with the cryptocurrency represented by the tangible token 123-1. For example, graphic 1104 includes “5 B” which stands for 5 BITCOIN that is represented by the tangible token 123-1. The graphic 1104 indicates that the cryptocurrency tangible token 123-1 represent a block of 5 BITCOIN stored on the blockchain at particular address of the blockchain. Also, etched or engraved or lasered on the cryptocurrency tangible token 123-1 is a line 1100 that is not visible to the naked eye, in some embodiments. The line 1100 represents a private key associated with the cryptocurrency on the blockchain, a public key associated with the cryptocurrency on the blockchain, an address associated with the cryptocurrency on the blockchain, any other suitable information. The information represented by the line 1100 may be read with a magnifying glass, microscope, or similar enlarging device, and thus, is human-readable in some embodiments. Further, the information represented by the line 1100 may be read by the reading component 104 of the computing device 102, and thus, is machine-readable in some embodiments. The line 1100 may be visible through the transparent gemstone that forms the tangible token 123-1. The information may be digitized again by using a digital scanner with a high precision (e.g., above 20,000 dots per inch).

The NFT tangible token 123-2 includes associated with the cryptocurrency represented by the tangible token 123-2. For example, graphic 1106 includes “NFT” which may be a title associated with the NFT or a brand of the NFT. Further, the graphic 1106 includes a portrait of cars and a user. Any suitable image may be etched onto the NFT tangible token 123-2. In some embodiments, multiple images may be etched onto the tangible token 123-2. In some embodiments, the graphic 1106 is stored on the blockchain with the NFT at a particular address of the blockchain. Also, etched or engraved or lasered on the cryptocurrency tangible token 123-2 is a line 1102 that is not visible to the naked eye, in some embodiments. The line 1102 represents a private key associated with the NFT on the blockchain, a public key associated with the NFT on the blockchain, an address associated with the NFT on the blockchain, any other suitable information. The information represented by the line 1102 may be read with a magnifying glass, microscope, or the like, and thus, is human-readable in some embodiments. Further, the information represented by the line 1102 may be read by the reading component 104 of the computing device 102, and thus, is machine-readable in some embodiments. The line 1102 may be visible through the transparent gemstone that forms the tangible token 123-1.

In addition to the applications described above, tangible tokens may be used on other applications as part of a method for verify authenticity. One such application is in the field of semiconductors, where tangible tokens may be used to verify authenticity of a particular integrated circuit or computer system.

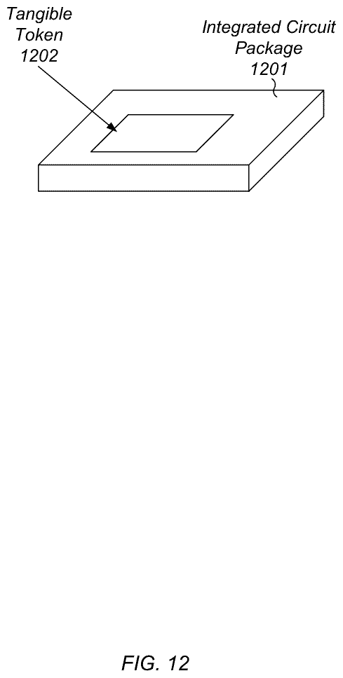

Turning to FIG. 12, a block diagram of an embodiment of an integrated circuit package with an associated with a tangible token is depicted. As illustrated, tangible token 1202 is coupled to integrated circuit package 1201. In various embodiments, tangible token 1202 may correspond to tangible token 123 as describe above.

In various embodiments, integrated circuit package 1201 may be implemented using a dual-inline pin (DIP) package, a plastic leaded chip carrier (PLCC) package, a ceramic DIP package, a ceramic pin grid array (PGA) package, a ceramic ball grid array (BGA) package, or any suitable type of semiconductor package. The type of package used for integrated circuit package 1201 may be determined, in part, by a type of integrated circuit, e.g., a processor circuit, to be mounted in integrated circuit package 1201.

The authenticity of tangible token 1202 can be verified by performing one or more tests. Once the authenticity of tangible token 1202 has been verified, information included in tangible token 1202 can be retrieved using a microscope or other suitable mechanism. In cases where the information is internally etched as a two-dimensional bar code, a processor, or other suitable device, may be employed to decode the two-dimensional bar code to retrieve the encoded information. When the information is internally etched into the tangible token as plain text, a processor, or other suitable device, may be employed to perform character recognition to create a computer-readable version of the information.

As described below, information may be included in tangible token 1202 in a form that can be read by the integrated circuit mounted in integrated circuit package 1201. In various embodiments, such information may include date of manufacture, manufacturing lot information, serial or other identifying number, and the like.

Using the information retrieved from tangible token 1202, a blockchain may be accessed. In various embodiments, a non-fungible tokens included in the blockchain may be retrieved. In some embodiments, information relating to maintenance logs, calibration data, and the like, may be encoded in the non-fungible token.

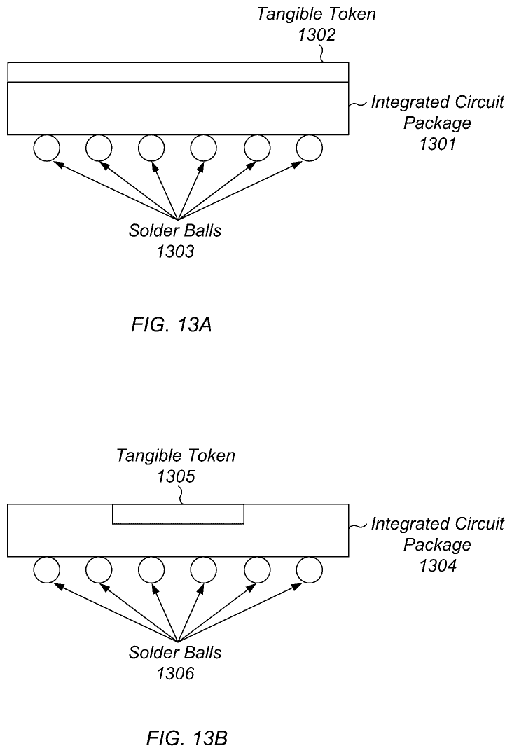

Turning to FIG. 13A, an example of a tangible token attached to an exterior of an integrated circuit package is depicted. In various embodiments, integrated circuit package 1301 and tangible token 1302 may correspond to integrated circuit package 1201 and tangible token 1202, respectively.

As illustrated, integrated circuit package 1301 includes solder balls 1303 that can be used to couple integrated circuit package 1301 to a circuit board or other suitable substrate. In various embodiments, integrated circuit package 1301 may be implemented using plastic, ceramic, or any other suitable material.

Tangible token 1302 is coupled to an exterior surface of integrated circuit package 1301 opposite of solder balls 1303. In various embodiments, tangible token 1302 may be affixed to integrated circuit package 1301 using glue, epoxy, or any other suitable adhesive. In some cases, the adhesive employed may be thermally conductive.

Turning to FIG. 13B, an example of a tangible token embedded in an integrated circuit package is depicted. In various embodiments, integrated circuit package 1304 and tangible token 1305 may correspond to integrated circuit package 1201 and tangible token 1202, respectively.

As illustrated, integrated circuit package 1304 includes solder balls 1306 that can be used to couple integrated circuit package 1304 to a circuit board or other suitable substrate. In various embodiments, integrated circuit package 1304 may be implemented using plastic, ceramic, or any other suitable material.

Tangible token 1305 is embedded into a surface of integrated circuit package 1304 opposite of solder balls 1306. In various embodiments, tangible token 1305 may be impressed into integrated circuit package 1304 during an injection molding step. In other cases, integrated circuit package 1304 may be manufactured to leave an indentation into which tangible token 1305 can be mounted using glue, epoxy, or any other suitable adhesive. In some cases, the adhesive employed may be thermally conductive.

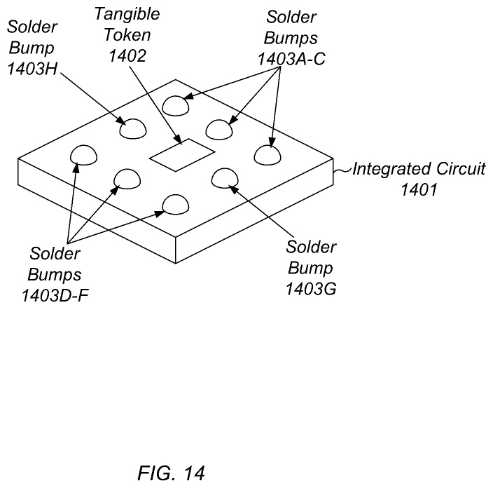

In some cases, a tangible token may be coupled to an unpackaged integrated circuit. A diagram illustrating such a situation is depicted in FIG. 14. As illustrated, integrated circuit 1401 includes solder bumps 1403A-H. Tangible token 1402 is coupled to integrated circuit 1401 between solder bumps 1403A-H. In various embodiments, tangible token 1402 may correspond to tangible token 123 as described above.

In various embodiments, integrated circuit 1401 may include a processor circuit, a memory circuit, one or more mixed-signal/analog circuits, and the like. In some cases, integrated circuit 1401 may be a system-on-a-chip (SoC).

As describe below, tangible token 1402 may make both electrical and thermal contact with circuits included in integrated circuit 1401. Although tangible token 1402 is depicted as being located in the center of integrated circuit 1401, in other embodiments, tangible token 1402 may be located in any suitable location on the surface of integrated circuit 1401. It is noted that tangible token 1402 may be in any suitable orientation relative to a particular origin on integrated circuit 1401.

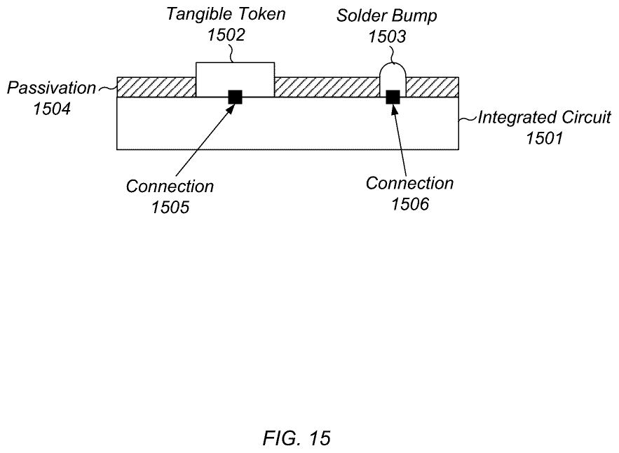

Turning to FIG. 15, an example of a cross-section of an integrated circuit with an attached tangible token is depicted. In various embodiments, integrated circuit 1501 and tangible token 1502 may correspond to integrated circuit 1401 and tangible token 1402, respectively.

As illustrated, openings are left in passivation 1504 during manufacture to allow solder bump 1503 and tangible token 1502 to connect to integrated circuit 1501 via connections 1506 and 1505, respectively. In various embodiments, passivation 1504 may be implemented using silicon nitride or any other suitable material that prevents moisture and other contaminates from reaching integrated circuit 1501.

Solder bump 1503 connects to integrated circuit 1501 via connection 1506. In various embodiments, connection 1506 may be implemented as a pad of aluminum, copper, or any other suitable conductive material available on a semiconductor manufacturing process. In some cases, solder bump 1503 may be connected to a signal port of integrated circuit 1501, while, in other embodiments, solder bump 1503 may be connected to either the power or ground grid included in integrated circuit 1501. Although a single solder bump is depicted in the embodiment of FIG. 15, in other embodiments, any suitable number of solder bumps may be employed.

Tangible token 1502 is coupled to integrated circuit 1501 via connection 1505. Although a single connection is depicted, in other embodiments, any suitable number of connections may be employed. In some embodiments, a number of connections may be based, at least in part, on a number of bits of data or information embedded in tangible token 1502. In various embodiments, terminals of tangible token 1502 may be coupled to corresponding pads of aluminum, copper, or any other suitable conductive material available on a semiconductor manufacturing process.

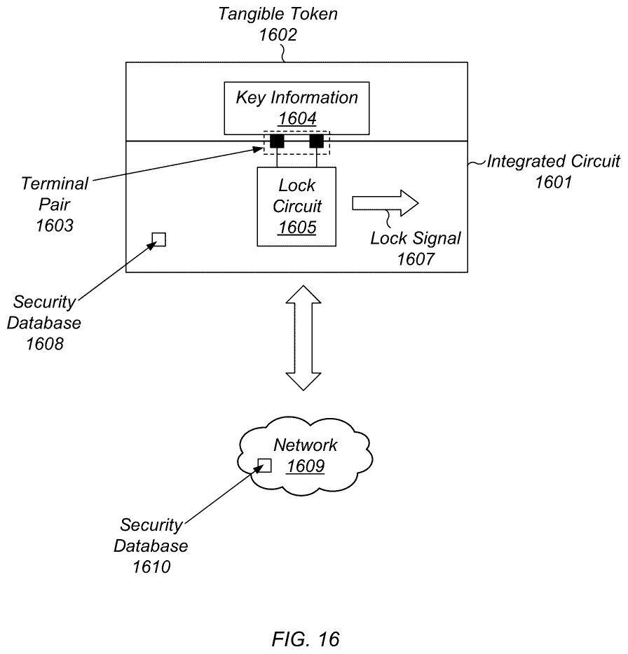

Turning to FIG. 16, a block diagram depicting an embodiment of an integrated circuit that includes a lock circuit coupled to a tangible token is depicted. As illustrated, integrated circuit 1601 includes lock circuit 1605 and security database 1608, while tangible token 1602 includes key information 1604. In various embodiments, integrated circuit 1601 and tangible token 1602 may correspond to integrated circuit 1401 and tangible token 1402, respectively.

Although tangible token 1602 is depicted as being coupled directly to integrated circuit 1601, in other embodiments, tangible token 1602 may be coupled to integrated circuit 1601 using an interposer or other suitable structure. Such an interposer can translate the position and pitch of terminals on tangible token 1602 to match an allowed metal spacing on integrated circuit 1601. Additionally, the interposer can provide a patch from terminals located on the edge of tangible token 1602 to metal traces on integrated circuit 1601.

As described below, key information 1604 may be stored in tangible token 1602 using the presence or absence of conductive paths between terminal pairs, e.g., terminal pair 1603. Although only a single terminal pair, which corresponds to a single bit of data, is depicted in the embodiment of FIG. 16, in other embodiments, any suitable number of terminal pairs may be employed.

In response to an authentication operation, boot operation, or any other suitable operation, lock circuit 1605 is configured to retrieve or “read” key information 1604 from tangible token 1602. To retrieve key information 1604 from tangible token 1602, lock circuit 1605 is further configured to apply a voltage to a first terminal of terminal pair 1603, and sense a voltage of a second terminal of terminal pair 1603. Alternatively, lock circuit 1605 may be configured to pre-charge the first terminal to a particular voltage and then couple the second terminal to a ground supply node. After the second terminal has been coupled to the ground supply node, lock circuit 1605 may measure a voltage level on the first terminal. As described below, key information 1604 may be stored as true and/or complement data in tangible token 1602.

In various embodiments, lock circuit 1605 in conjunction with tangible token 1602 can be considered as a read-only memory (ROM) circuit, with the stored information being located in tangible token 1602 and the read (or “sensing”) circuits located in lock circuit 1605. In cases where tangible token 1602 is implemented using a diamond, the combination of lock circuit 1605 and tangible token 1602 can be considered as a diamond-based ROM.

Lock circuit 1605 is further configured to perform a comparison using the measured voltage. To perform the comparison operation, lock circuit 1605 is further configured to compare the measure to one or more threshold values stored in security database 1608 or in security database 1610 which is access via network 1609 to obtain all or a part of the threshold values. In various embodiments, multiple threshold values can be employed to account for variation in resistance in the conductive traces that store key information 1604. In some cases, if the measured voltage falls outside the range defined by the multiple threshold values, lock circuit 1605 may trigger a security operation as described below.

In some embodiments, security databases 1608 and 1610 may include one or more corresponding security tokens. In such cases, lock circuit 1605 may be configured to perform two-factor authentication using key information 1604 and the security tokens. In cases where the two-factor authentication fails, lock circuit 1605 may be configured to perform security operations as described below.

In various embodiments, lock circuit 1605 is also configured to perform at least one security operation based on a result of the comparison. In some embodiments, the at least one security operation can include activating lock signal 1607, which can disable one or more portions of integrated circuit 1601. In some embodiments, integrated circuit 1601 may include clock generation circuits and local power generation circuits that are configured to halt operation in response to an activation of lock signal 1607, thereby rendering integrated circuit 1601 inoperable. In other embodiments, lock circuit 1605 may include a fuse or one-time programmable memory circuit, and activating lock signal 1607 can include blowing the fuse or writing a particular value to the one-time programmable memory circuit. In various embodiments, blowing the fuse or writing the particular value can result in lock signal 1607 becoming permanently active even if power is removed from integrated circuit 1601 in an attempt to circumvent the security operations.

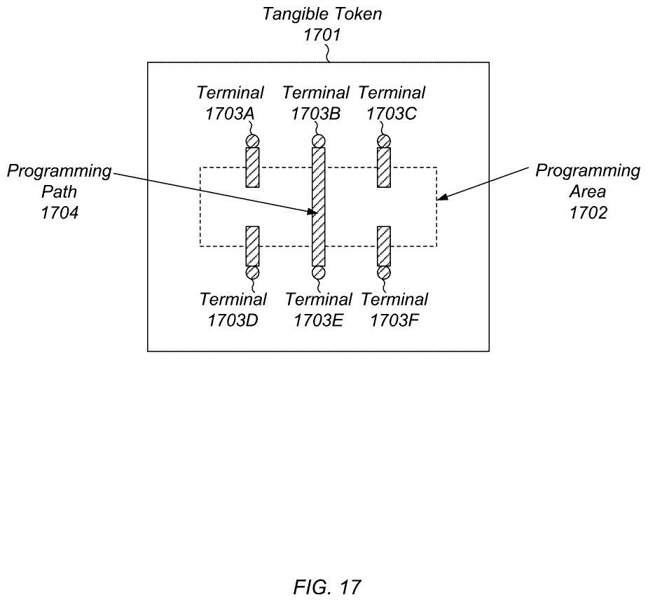

Turning to FIG. 17, an example of a tangible token is depicted. In various embodiments, tangible token 1701 may be implemented as a transparent gemstone and may correspond to tangible token 1202 or any of the other previously described tangible tokens.

As illustrated, tangible token 1701 includes terminals 1703A-1703F. In various embodiments, terminals 1703A-1703F are located such that they can connect with corresponding metal pads on an integrated circuit, e.g., integrated circuit 1401. Moreover, individual ones of terminals 1703A-1703C are paired with corresponding ones of terminals 1703D-1703F. For example, terminal 1703A is paired with terminal 1703D. Although only three pairs of terminals are depicted in the embodiment of FIG. 17, in other embodiments, any suitable number of terminal pairs may be employed.

Tangible token 1701 further includes programming area 1702 which is located between the corresponding pairs of terminals 1703A-1703F. In programming area 1702, one or more programming paths may be etched such that a conductive path is formed. For example, programming path 1704 is a conductive path between terminal pair 1703B and 1703E, while terminal pair 1703A and 1703C do not have a conductive path. The path may be made conductive by generating graphene between a terminal pair.

The difference in conduction between terminal pairs with a conductive path and terminal pairs without a conductive path can be used to store information referred to as “key information” that can be retrieved or “read” using a lock circuit included in an integrated circuit. For example, true data may be stored where a conductive path between a particular terminal pair may correspond to a logic-1 value, while the absence of a conductive path between a different terminal pair may correspond to a logic-0 value. In other cases, the key information may be stored as complement data where a conductive path between a particular terminal pair may correspond to a logic-0 value, while the absence of a conductive path between a different terminal pair may correspond to a logic-1 value. In some embodiments, the information stored in the presence and absence of conductive paths may be encoded and, prior to being used by the integrated circuit, may need to be decoded. In various embodiments, different tangible tokens would have different key information stored in them allowing unique tangible tokens to be paired with corresponding integrated circuits, integrated circuit packages, circuit boards, and the like.

In cases where tangible token 1701 is implemented using a diamond, the programming paths, e.g., programming path 1704, may be created in programming area 1702 at a nanometer scale taking advantage of the high electrical resistance of diamond. By creating the programming paths at such a scale, a large number of bits may be stored in a small area of tangible token 1701.

In various embodiments, the information stored in tangible token 1701 may include a serial or other identification number associated with a corresponding integrated circuit. In some embodiments, the information stored in tangible token 1701 may also include manufacturing information associated with the corresponding integrated circuit, such as date of manufacture, manufacturing lot, and the like.

Although the embodiment of FIG. 17 depicts terminals 1703A-1703F as being located on a top or bottom surface of tangible token 1701, in other embodiments, terminals 1703A-1703F can be located in any suitable location on tangible token 1701. For example, in some cases, terminals 1703A-C may be located on a particular edge of tangible token 1701, while terminals 1703D-F may be located on a different edge of tangible token 1701 that is adjacent to the particular edge.

In some cases, attempts to circumvent the authentication provided by using a tangible token may include removal of the tangible token from an integrated circuit package or from an integrated circuit. To detect the removal of the tangible token, an integrated circuit may be configured to perform a thermal check.

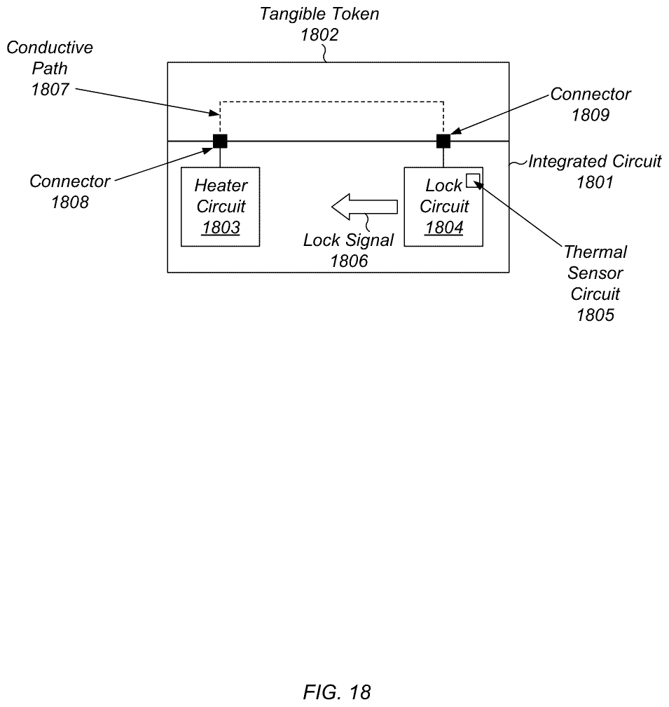

Turning to FIG. 18, a block diagram of an integrated circuit configured to check for the presence of a tangible token using a thermal check is depicted. As illustrated, integrated circuit 1801 includes heater circuit 1803 and lock circuit 1804, which includes thermal sensor circuit 1805. In various embodiments, integrated circuit 1801 and tangible token 1802 may correspond to integrated circuit 1401 and tangible token 1402, respectively. It is noted that integrated circuit 1801 may include various other circuit blocks which have been omitted from FIG. 18 for clarity.

In various embodiments, integrated circuit 1801 is configured to perform the thermal check during a boot operation of a computer system, during an incoming quality inspection, or in response to any other suitable stimulus. To perform the thermal check, heater circuit 1803 is configured to generate a particular amount of heat on connector 1808. The applied heat travels through tangible token 1802 via conductive path 1807 to connector 1809.

Thermal sensor circuit 1805 is configured to sense a temperature of connector 1809. Based on the detected temperature, lock circuit 1804 is configured to generate lock signal 1806. In some embodiments, lock circuit 1804 is configured to activate lock signal 1806 is response to a determination that the temperature of connector 1809 is less than a threshold value, indicating that the heat generated by heater circuit 1803 did not have a medium through which to propagate, i.e., tangible token 1802 has been removed.

In various embodiments, integrated circuit 1801 may be configured to generate a warning message in response to an activation of lock signal 1806. Alternatively, or additionally, integrated circuit 1801 may be configured to disable portions of integrated circuit 1801 in response to the activation of lock signal 1806. For example, in response to the activation of lock signal 1806, integrated circuit 1801 may disable clock circuits, local power generation circuits, and the like. In some cases, integrated circuit 1801 may blow a fuse or write a particular value into a one-time programmable memory to make the disabling of the clock circuits, local power circuits, etc., permanent.

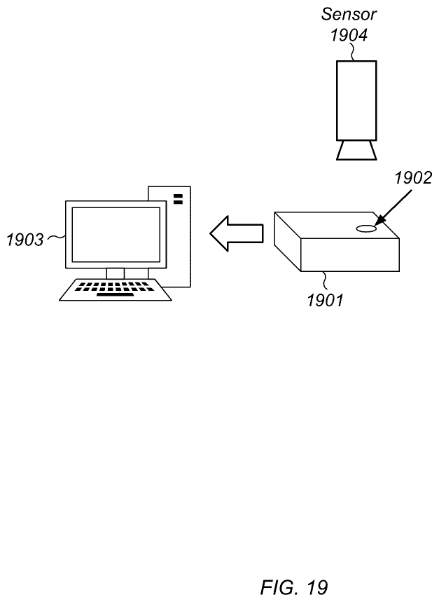

Turning to FIG. 19, an example of a system to verify the authenticity of a packaged integrated circuit to be included in a computer system is depicted. As illustrated, packaged integrated circuit 1901 includes tangible token 1902. In various embodiments, packaged integrated circuit 1901 and tangible token 1902 correspond to integrated circuit package 1201 and tangible token 1902, respectively.

During the assembly of computer system 1903, sensor 1904 scans tangible token 1902. In various embodiments, information internally etched into tangible token 1902 may be retrieved. Using the retrieved information, additional information relating to the integrated circuit mounted in integrated circuit package 1901 may be retrieved using a private key associated with a blockchain. Such information relating to the integrated circuit mounted in integrated circuit package 1901 may be entered into a manufacturing record for computer system 1903.

As described above, tangible token 1902 may include additional information encoded using conductive regions embedded in tangible token 1902. In such cases, the integrated circuit mounted in integrated circuit package 1901 may retrieve the additional information from tangible token 1902 as described above. The additional information may also be entered into the manufacturing record for computer system 1903.

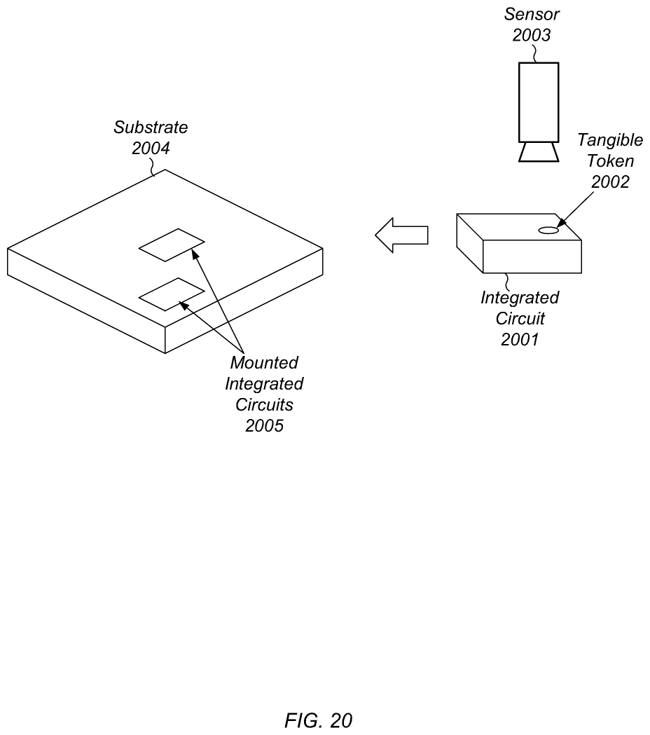

Turning to FIG. 20, an example of a system to verify the authenticity of an unpackaged integrated circuit to be mounted on a circuit board or substrate is depicted. As illustrated, substrate 2004 includes mounted integrated circuits 2005. In various embodiments, substrate 2004 may correspond to a circuit board, interposer, or any other suitable substrate on which integrated circuits can be mounted.

Prior to the mounting of integrated circuit 2001 onto substrate 2004, sensor 2003 scans tangible token 2002. In various embodiments, information internally etched into tangible token 2002 may be retrieved. Using the retrieved information, additional information relating to integrated circuit 2001 may be retrieved using a private key associated with a blockchain. Such information relating to integrated circuit 2001 may be entered into a manufacturing record for substrate 2004.

As described above, tangible token 2002 may include additional information encoded using conductive regions embedded in tangible token 2002. In such cases, integrated circuit 2001 may retrieve the additional information from tangible token 2002 as described above. The additional information may also be entered into the manufacturing record for substrate 2004.

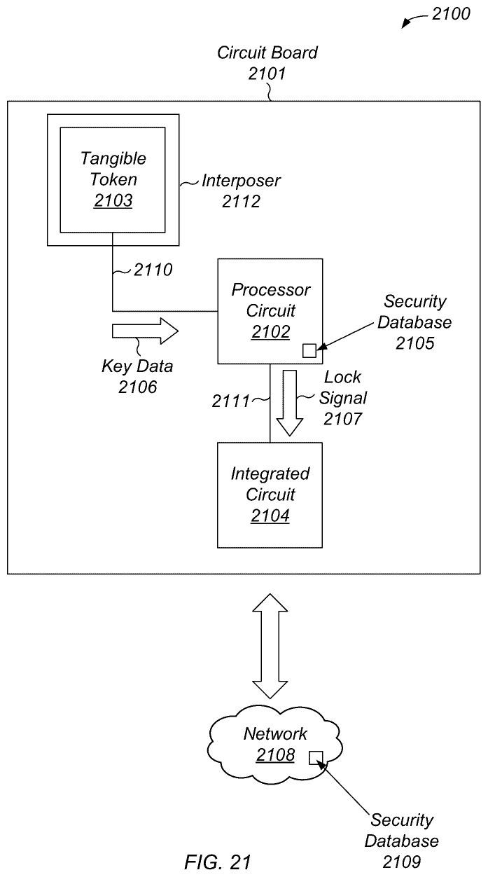

In some cases, a tangible token in the form of a transparent gemstone may be included in circuit boards or other substrates of a computer system, not just packaged or unpackaged integrated circuits. A block diagram of a computer system that includes a tangible token is depicted in FIG. 21. As illustrated, computer system 2100 includes processor circuit 2102, tangible token 2103, and integrated circuit 2104, all coupled to circuit board 2101.

As described above, tangible token 2103 may include embedded information, i.e., key data 2106, related to computer system 2100. In various embodiments, the information may be encoded using conductive regions formed in tangible token 2103. In some cases, tangible token 2103 may be coupled directly to circuit board 2101. In other embodiments, tangible token 2103 may be coupled using optional interposer 2112. In various embodiments, interposer 2112 may increase the pitch between terminals of tangible token 2103 to match an allowable pitch for metal traces on circuit board 2101. In cases where tangible token 2103 has terminals located on one or more of its edges, interposer 2112 may include vertical sides to couple to the edge terminals of tangible token 2103.

Processor circuit 2102 includes security database 2105 and is configured to retrieve key data 2106 from tangible token 2103. To retrieve key data 2106 from tangible token 2103, processor circuit 2102 may be configured to apply currents and/or voltages to a first set of terminals included in tangible token 2103 via a first set of traces included in traces 2110, and sense resultant voltages on a second set of terminals included in tangible token 2103 via a second set of traces included in traces 2110.

Processor circuit 2102 is also configured to perform a comparison of key data 2106 to information included in security database 2105. Alternatively, or additionally, processor circuit 2102 may be configured to perform a comparison between key data 2106 and information included in security database 2109 via network 2108. It is noted that network 2108 may be a wired network or a wireless network.

In various embodiments, processor circuit 2102 is configured to activate lock signal 2107 based on a result of the above described comparison. In some cases, processor circuit 2102 may be configured to activate lock signal 2107 in response to a determination that key data 2106 does not match corresponding information included in security database 2105 and/or security database 2109. In various embodiments, such a determination may indicate that one or more of the components of computer system 2100 may be counterfeit components. In some embodiments, processor circuit 2102 may be configured to generate a warning message in response to the determination that key data 2106 does not match corresponding information included in security database 2105 and/or security database 2109.

Integrated circuit 2104 is configured to halt or disable computer system 2100 in response to an activation of lock signal 2107. In some embodiments, integrated circuit 2104 may be a power management integrated circuit configured to generate power supply voltages for processor circuit 2102 and other integrated circuits included in computer system 2100, and, in response to an activation of lock signal 2107, integrated circuit 2104 may halt the generation of such power supply voltages. In some cases, integrated circuit 2104 may blow a fuse or set a bit in a non-volatile memory circuit in response to the activation of lock signal 2107. In various embodiments, blowing the fuse or setting the bit may permanently disable integrated circuit 2104, rendering computer system 2100 inoperable. It is noted that although only one integrated circuit is depicted in the embodiment of FIG. 21, in other embodiments, any suitable number of integrated circuits may be employed, and any of the integrated circuits may perform operations or disable themselves in response to an activation of lock signal 2107.

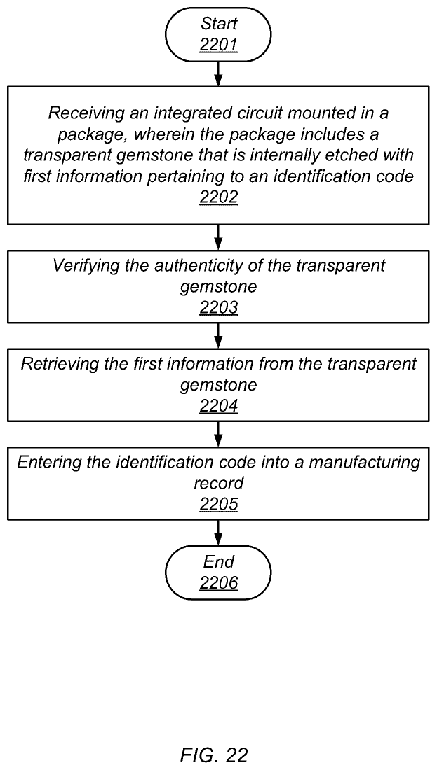

Turning to FIG. 22, a flow diagram depicting an embodiment of a method for authenticating a packaged integrated circuit using a tangible token in the form of a transparent gemstone is illustrated. The method, which may be used with a variety of integrated circuits, begins in block 2201.

The method includes receiving an integrated circuit mounted in a package (block 2202). In various embodiments, the integrated circuit package is coupled to a transparent gemstone that is internally etched with first information pertaining to an identification code. In some cases, the transparent gemstone may be electrically coupled to the integrated circuit via conductive traces in the package.

In some embodiments, the identification code may comprise a serial number or other unique identification information. In other embodiments, the first information may also include a key associated with a blockchain. In some embodiments, the first information may be included in a two-dimensional bar code internally etched into the transparent gemstone.

The method further includes verifying the authenticity of the transparent gemstone (block 2203). In some embodiments, verifying the authenticity of the transparent gemstone may include performing one or more tests, and determining, based on results of the one or more tests, the authenticity of the transparent gemstone. In some embodiments, verifying the authenticity of the transparent gemstone may be performed prior to the integrated circuit being mounted on a circuit board or other suitable substrate included in a computer system.

The method also includes retrieving the first information from the transparent gemstone (block 2204). In various embodiments, retrieving the first information from the transparent gemstone includes imaging a portion of the transparent gemstone that contains internal etching. In cases where the first information also includes a key associated with a blockchain, the method may additionally include accessing the blockchain via a network, and retrieving second information from the blockchain. In various embodiments, the second information may include identifying information for the integrated circuit, such as manufacturing lot, date of manufacture, etc. In some cases, retrieving the first information from the transparent gemstone may include reading, by the integrated circuit, digital information embedded in the transparent gemstone in the form of conductive regions within the transparent gemstone. In various embodiments, such retrieved information may include identifying information for the integrated circuit, such as manufacturing lot, date of manufacture, and the like.

The method further includes entering the identifying information for the integrated circuit into a manufacturing record for a computer system (block 2205). In various embodiments, the method may also include entering the second information into the manufacturing record. The method ends at block 2206.

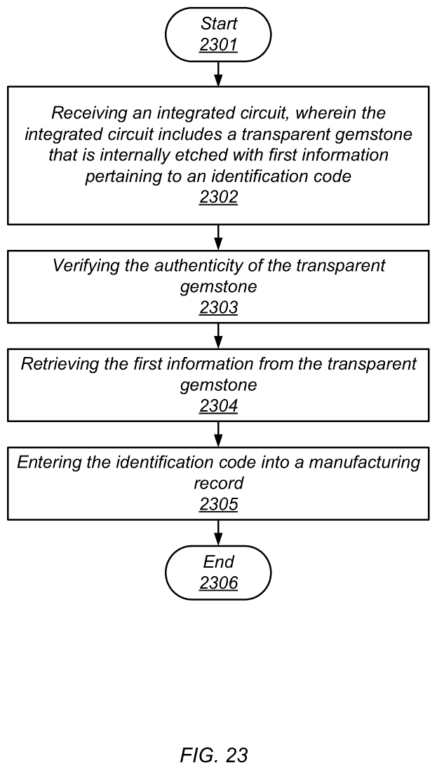

Turning to FIG. 23, a flow diagram depicting an embodiment of a method for authenticating an unpackaged integrated circuit using a tangible token in the form of a transparent gemstone is illustrated. The method, which may be used with a variety of integrated circuits, begins in block 2301.

The method includes receiving an integrated circuit (block 2302). In various embodiments, the integrated circuit is coupled to a transparent gemstone that is internally etched with first information pertaining to an identification code. In various embodiments, the transparent gemstone may be electrically and/or thermally coupled to the integrated circuit.

In some embodiments, the identification code may comprise a serial number or other unique identification information. In other embodiments, the first information may also include a key associated with a blockchain. In some embodiments, the first information may be included in a two-dimensional bar code internally etched into the transparent gemstone.

The method further includes verifying the authenticity of the transparent gemstone (block 2303). In some embodiments, verifying the authenticity of the transparent gemstone may include performing one or more tests, and determining, based on results of the one or more tests, the authenticity of the transparent gemstone. In some embodiments, verifying the authenticity of the transparent gemstone may be performed prior to the integrated circuit being mounted on a circuit board or other suitable substrate included in a computer system.

The method also includes retrieving the first information from the transparent gemstone (block 2304). In various embodiments, retrieving the first information from the transparent gemstone includes imaging a portion of the transparent gemstone that contains internal etching. In cases where the first information also includes a key associated with a blockchain, the method may additionally include accessing the blockchain via a network, and retrieving second information from the blockchain. In various embodiments, the second information may include identifying information for the integrated circuit, such as manufacturing lot, date of manufacture, etc. In some cases, retrieving the first information from the transparent gemstone may include reading, by the integrated circuit, digital information embedded in the transparent gemstone in the form of conductive regions within the transparent gemstone. In various embodiments, such retrieved information may include identifying information for the integrated circuit, such as manufacturing lot, date of manufacture, and the like.

The method further includes entering the identification code into a manufacturing record for a computer system (block 2305). In various embodiments, the method may also include entering the second information into the manufacturing record. The method ends at block 2306.

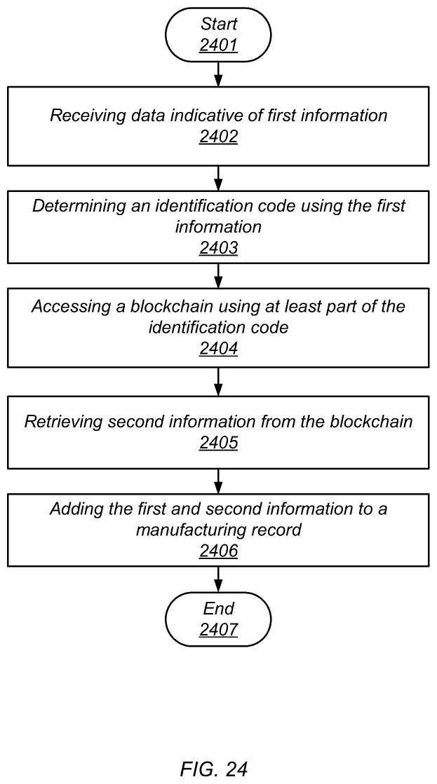

Turning to FIG. 24, a flow diagram depicting an embodiment of a method for retrieving data regarding an integrated circuit using information internally etched into a tangible token attached to an integrated circuit, or to a package into which the integrated circuit is mounted, is illustrated. It is noted that the method depicted in FIG. 24 may be performed by one or more processors executing program or software instructions stored on a tangible computer-readable storage medium. The method, which may correspond to block 2202 of FIG. 22, or block 2302 of FIG. 23, begins in block 2401.

The method includes receiving data indicative of first information internally etched in a tangible token (block 2402). In various embodiments, the data may comprise digital data encoding a serial number, a manufacturing lot number, a security code, and/or a private key, pertaining to a blockchain.

The method also includes determining an identification code using the first information (block 2403). In various embodiments, the digital data may include image data, wherein determining the identification code may include performing character recognition on the digital data. In other embodiments, determining the identification code may include decoding a two-dimensional bar code.

The method further includes accessing a blockchain using at least part of the identification code (block 2404). In various embodiments, accessing the blockchain may include extracting key information from the identification code, and transmitting the key information via a computer network.

The method also includes retrieving second information from the blockchain (block 2405). In some embodiments, retrieving the second information from the blockchain may include retrieving one or more NFTs from the blockchain, and extracting the second information from the one or more NFTs. In some embodiments, the second information may include additional information regarding the manufacture of the integrated circuit including, but not limited to, versions of photomasks used in the manufacture of the integrated circuit.

The method further includes adding the first and second information to a manufacturing record (block 2406). In various embodiments, the manufacturing record may include similar information for other integrated circuits included in a computer system, such as a server, desktop computer, laptop computer, and the like. The method concludes in block 2407.

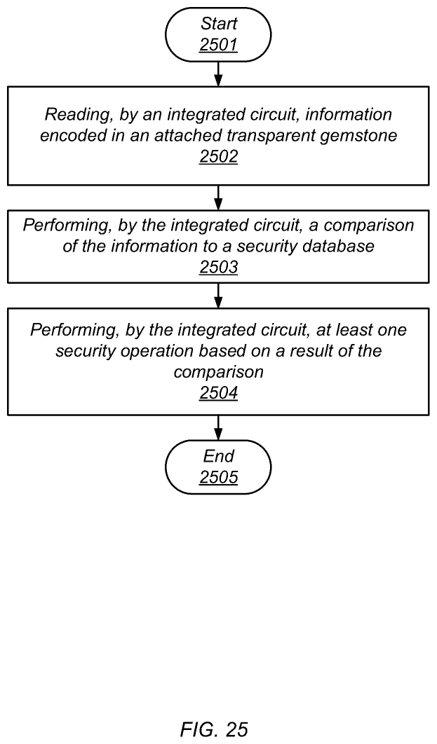

Turning to FIG. 25, a flow diagram depicting an embodiment of a method for performing an authenticity check for an integrated circuit using information included in a transparent gemstone is illustrated. The method, which begins in block 2501, may be applied to either an integrated circuit mounted in a package, or a raw integrated circuit die. In various embodiments, the method may be performed as part of boot operation of a computer system, or during an incoming quality inspection prior to assembly of a computer system.

The method includes reading, by the integrated circuit, information encoded in an attached transparent gemstone (block 2502). As described above, the information encoded in the transparent gemstone may correspond to the presence, or absence, of a conducting materials, e.g., graphene, between terminals that are electrically connected to the integrated circuit. The information may include any suitable number of bits that correspond to a serial number or other identifying information.

In various embodiments, reading the information encoded in the attached transparent gemstone may include sourcing a current, or applying a voltage, to a particular terminal of the transparent gemstone. The method may further include checking a voltage level of a terminal corresponding to the particular terminal. In various embodiments, the presence of the conductive material between the two terminals can result in a particular voltage on the corresponding terminal, while the absence of the conductive material can result in a different voltage on the corresponding terminal. The different voltage levels can, in various embodiments, correspond to different logic values, e.g., a logical-1 value or a logical-0 value. It is noted that other methods, such as pre-charging a terminal to a particular voltage and coupling a corresponding terminal to ground, may also be used to detect the presence, or absence, of a conductive trace between the terminals.

The method also includes performing, by the integrated circuit, a comparison of the information to a security database (block 2503). In various embodiments, the security database may be programmed into the integrated circuit during manufacture using fuses, metal mask options, and the like. Counterfeit integrated circuits may not have the correct information in the security database. In other embodiments, the security database may be located on a computer server, and the integrated circuit may access the security database via a computer network.

The method further includes performing, by the integrated circuit, at least one security operation based on a result of the comparison (block 2504). In various embodiments, performing the at least one security operation includes disabling clock generation and/or power generation circuits. In other embodiments, the method may further include, once clock generation and/or power generation circuits have been disabled, blowing a fuse or writing a particular bit to a one-time programmable memory to permanently disable the integrated circuit. The method concludes in block 2505.

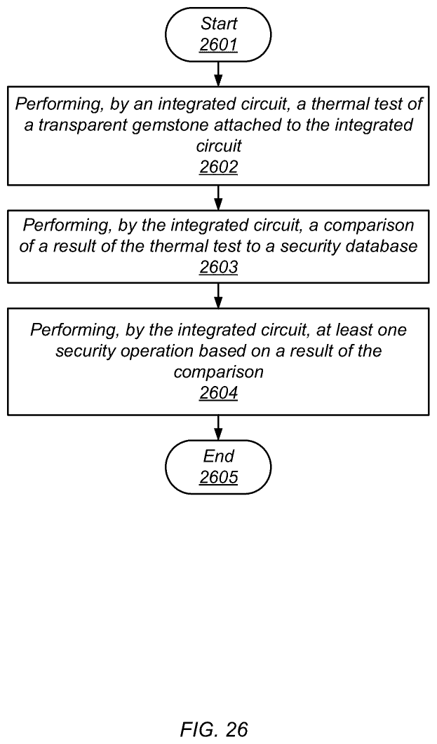

Turning to FIG. 26, a flow diagram depicting an embodiment of a method for performing a thermal check of a tangible token coupled to an integrated circuit is illustrated. The method, which may be applied to various integrated circuits, e.g., integrated circuit 1401, begins in block 2601. It is noted that the method depicted in FIG. 26 may, in some embodiments, be used in conjunction with the method depicted in the flow diagram of FIG. 25.

The method includes performing, by the integrated circuit, a thermal test of the tangible token in the form of a transparent gemstone attached to the integrated circuit (block 2602). Performing the thermal test may including heating a connection to the transparent gemstone, and measuring a temperature of a corresponding different connection to the transparent gemstone. In some cases, heating the connection to the transparent gemstone may include sourcing a current to one or more resistors, while measuring the temperature of the different connection may include sensing a change in the silicon bandgap as it is affected by the temperature of the different connection.

The method also includes performing, by the integrated circuit, a comparison of a result of the thermal test to a security database (block 2603). In various embodiments, the security database may be located in the integrated circuit, and the information included in the security database may be loaded during manufacture. Alternatively, the security database may be located on a computer network. In some embodiments, the security database includes multiple temperature threshold values, e.g., an upper threshold value and a lower threshold value.

Performing the comparison may include comparing a measured temperature of the different connections to the threshold values. In various embodiments, if the measured temperature is outside of the range of the threshold values, a negative result of the test may be indicated. The threshold values may be set to correspond to thermal properties of the transparent gemstone. Excursions beyond the threshold values could indicate a counterfeit or missing transparent gemstone.

The method further includes performing, by the integrated circuit, at least one security operation based on a result of the comparison (block 2604). In various embodiment, performing the at least one security operation includes disabling clock generation and/or power generation circuits. In other embodiments, the method may further include, once clock generation and/or power generation circuits have been disabled, blowing a fuse or writing a particular bit to a one-time programmable memory to permanently disable the integrated circuit. The method concludes in block 2605.

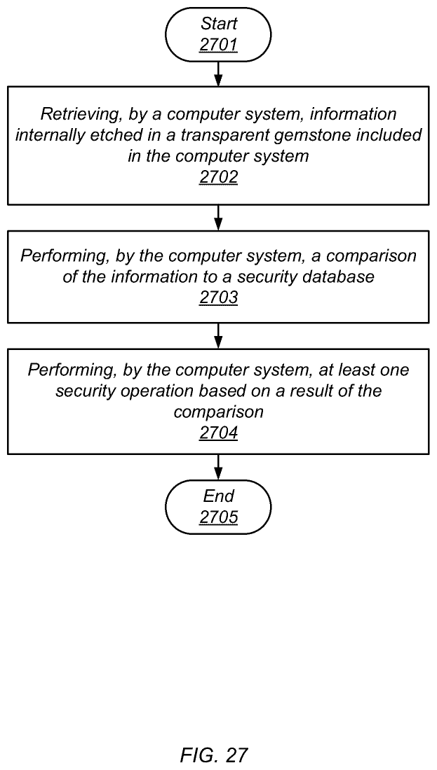

As described above, a transparent gemstone may be included in a computer system in addition to being attached to one or more integrated circuits included in the computer system. In such cases, the transparent gemstone may be attached to a circuit board or other suitable substrate included in the computer system. A flow diagram depicting a method for operating a computer system that includes a transparent gemstone with embedded information is depicted in FIG. 27. The method, which may be applied to various computer systems, begins in block 2701.

The method includes retrieving, by the computer system, information internally etched in a transparent gemstone included in the computer system (block 2702). In various embodiments, the information encoded in the transparent gemstone may correspond to the presence or absence of a conducting material, e.g., graphene, between terminals that are electrically connected to the integrated circuit. The information may include any suitable number of bits that correspond to a serial number or other identifying information related to the computer system.

In various embodiments, retrieving the information encoded in the attached transparent gemstone may include sourcing a current, or applying a voltage, to a particular terminal of the transparent gemstone. The method may further include checking a voltage level of a terminal corresponding to the particular terminal. In various embodiments, the presence of the conductive material between the two terminals can result in a particular voltage on the corresponding terminal, while the absence of the conductive material can result in a different voltage on the corresponding terminal. The different voltage levels can, in various embodiments, corresponding to different logic values, e.g., a logical-1 value or a logical-0 value. It is noted that, in some embodiments, retrieving the information from the transparent gemstone may be performed by a processor included in the computer system. In other embodiments, retrieving the information may be performed by a dedicated security, or authentication, circuit.

The method also includes performing, by the computer system, a comparison of the information to a security database (block 2703). In various embodiments, the security database may be programmed into a processor or other suitable integrated circuit included in the computer system during manufacture using fuses, metal mask options, and the like. Counterfeit computer systems or components included therein, may not be able to replicate the information included in the security database. In other embodiments, the security database may be located on a computer server, and the integrated circuit may access the security database via a computer network.

The method further includes performing, by the computer system, at least one security operation based on a result of the comparison (bock 2704). In cases, where the information retrieved from the transparent gemstone matches information included in the security database, the computer system may take no further action and allow normal operation.

In cases where the information retrieved from the transparent gemstone and the security database do not match, the method may include performing, by the computer system, a security operation. Performing the security operation may, in various embodiments, include activating a lock signal. In some cases, the method may include disabling, in response to activating the lock signal, clock and/or power supply circuits, rendering the computer system inoperable. In other cases, the method may include, in response to activating the lock signal, blowing, by the computer system, a non-replaceable fuse that renders the computer system inoperable.

Alternatively, or additionally, the method may include sending, by the computer system, a message to one or more of the manufacturers of the integrated circuits indicating a possible failure to authenticate, and that the integrated circuits may be mounted in a counterfeit circuit board or computer system. The method concludes in block 2705.

The foregoing description, for purposes of explanation, used specific nomenclature to provide a thorough understanding of the described embodiments. It should be apparent, however, to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method, comprising:
receiving an integrated circuit for use in a computer system, wherein a transparent gemstone is affixed to the integrated circuit, and wherein the transparent gemstone is internally etched with first information pertaining to the integrated circuit;
reading, by the integrated circuit, the first information from the transparent gemstone;
performing, by the integrated circuit, a comparison of the first information to a security database; and
performing, by the integrated circuit, at least one security operation based on a result of the comparison.

2. The method of claim 1, wherein performing the at least one security operation includes disabling one or more circuit blocks in the integrated circuit in response to determining that the first information does not match corresponding information in the security database.

3. The method of claim 1, wherein performing the comparison includes accessing, by the integrated circuit, the security database via a network.

4. The method of claim 1, wherein the transparent gemstone comprises a diamond, wherein the first information is stored in the diamond using a plurality of conductive traces between corresponding pairs of terminals of a plurality of terminals of the diamond, and wherein reading the first information includes:
pre-charging a first subset of the plurality of terminals to ground potential;
applying a voltage to a second subset of the plurality of terminals that correspond to the first subset of the plurality of terminals;
measuring respective voltage levels of the first set of terminals; and
determining a set of logic values using the respective voltage levels of the first set of terminals.

5. The method of claim 1, further comprising performing, by the integrated circuit, a thermal check associated with the transparent gemstone.

6. The method of claim 1, further comprising verifying an authenticity of the transparent gemstone.

7. An apparatus, comprising:
a computer system;
an integrated circuit;
a transparent gemstone affixed to the integrated circuit, wherein the transparent gemstone is internally etched with first information; and
a sensor configured to:
scan the transparent gemstone affixed to a package for an integrated circuit to retrieve the first information internally etched into the transparent gemstone; and
store the first information in a manufacturing database for the computer system.

8. The apparatus of claim 7, wherein the transparent gemstone is further internally etched with second information using at least one electrically conductive path between two terminals of a plurality of terminals of the transparent gemstone.

9. The apparatus of claim 8, wherein the integrated circuit is configured to retrieve the second information from the transparent gemstone.

10. The apparatus of claim 9, wherein the integrated circuit is further configured to:
perform a comparison of the first information to a security database; and
perform at least one security operation based on a result of the comparison.

11. The apparatus of claim 10, wherein the security database is included in the integrated circuit.

12. The apparatus of claim 10, wherein the security database is external to the integrated circuit, and wherein to perform the comparison, the integrated circuit is further configured to access the security database via a network.

13. The apparatus of claim 10, wherein to perform the at least one security operation, the integrated circuit is further configured to disable one or more circuit blocks in the integrated circuit in response to determining that the first information does not match corresponding information in the security database.

14. A computer system, comprising:
a plurality of integrated circuits;
a transparent gemstone that includes a plurality of conductive paths coupled between corresponding terminals, wherein first information is stored in the transparent gemstone using the plurality of conductive paths; and
a processor circuit configured to:
read the first information from the transparent gemstone;
perform a comparison of the first information to a security database; and
perform at least one security operation based on a result of the comparison.

15. The computer system of claim 14, wherein the processor circuit includes a plurality of circuit blocks, and wherein to perform the at least one security operation, the processor circuit is further configured to disable one or more circuit blocks of the plurality of circuit blocks in response to a determination that the first information does not match corresponding information in the security database.

16. The computer system of claim 14, wherein to perform the at least one security operation, the processor circuit is further configured to disable at least one integrated circuit of the plurality of integrated circuits.

17. The computer system of claim 14, wherein to perform the comparison, the processor circuit is further configured to access the security database via a network coupled to the processor circuit.

18. The computer system of claim 14, wherein to read the first information, the processor circuit is further configured to:
apply a voltage to a first set of terminals of the plurality of terminals; and
measure respective voltage levels of a second set of terminals of the plurality of terminals corresponding to the first set of terminals.

19. The computer system of claim 14, wherein the transparent gemstone, the processor circuit, and the plurality of integrated circuits are mounted on a common substrate.

20. The computer system of claim 14, wherein the transparent gemstone comprises a diamond.
